(19) United States
(12) Patent Application Publication
(10) Pub. No.: US 2025/0097978 A1
(43) Pub. Date: Mar. 20, 2025

(54) USER EQUIPMENT, BASE STATION, AND CHANNEL ACCESS METHOD

(71) Applicant: PURPLEVINE INNOVATION COMPANY LIMITED, Hong Kong (HK)

(72) Inventor: Chun-Che CHIEN, Hong Kong (HK)

(73) Assignee: PURPLEVINE INNOVATION COMPANY LIMITED, Hong Kong (HK)

(21) Appl. No.: 18/293,311

(22) PCT Filed: Jul. 29, 2022
(86) PCT No.: PCT/CN2022/109159

§ 371 Date: Jan. 29, 2024

Related U.S. Application Data
(63) Continuation-in-part of application No. PCT/CN2021/140171, filed on Dec. 21, 2021.
Application No. PCT/CN2021/140171 is a continuation-in-part of application No. PCT/CN2022/091283, filed on May 6, 2022.
(60) Provisional application No. 63/226,774, filed on Jul. 29, 2021.

(30) Foreign Application Priority Data
Dec. 21, 2021 (WO) PCT/CN2021/140171
Dec. 21, 2021 (WO) PCT/CN2022/091283

(51) Int. Cl. H04W 74/0816; H04W 74/00; H04W 74/04; H04W 74/08

(52) U.S. Cl. CPC H04W 74/0816; H04W 74/006; H04W 74/04; H04W 74/0875

(57) ABSTRACT

A user equipment (UE) executes a semi-static channel access method in an unlicensed band. The UE receives a first downlink control information (DCI) within a fixed frame period (FFP), wherein the first DCI is for scheduling uplink (UL) transmissions over one or more FFPs. The UE derives, for each scheduled UL transmission of the scheduled UL transmissions, a channel occupancy time (COT) initiator of the scheduled UL transmission. The UE determines one or more transmission symbols for each of the scheduled UL transmissions according to the derived COT initiator. The UE transmits each of the scheduled UL transmissions in the one or more transmission symbols of the one or more FFPs.

### TECHNICAL FIELD

The present disclosure relates to the field of communication systems, and more particularly, to a user equipment, a base station, and semi-static channel access method in an unlicensed band.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

In NR-Unlicensed (NR-U), a channel occupancy time (COT) may be initiated by a base station or a UE in a fixed frame period (FFP). A device, such as a base station or a UE, initiates a COT is referred to as a COT initiator or an initiating device. COT has two COT types. A COT initiated by a gNB is referred to as a gNB-initiated COT. A COT initiated by a UE is referred to as a UE-initiated COT. Uplink (UL) transmission and downlink (DL) transmission between a UE and a base station in a COT are performed based on FFP parameters of a COT initiator of the COT.

Currently, determination of the COT initiator for scheduled UL transmissions or configured UL transmissions has following alternatives Alt-a or Alt-b. In a semi-static channel access mode when a UE can operate as an initiating device, one of the following alternatives may be selected to determine whether a UL transmission is based on a UE-initiated COT or sharing a gNB-initiated COT:
Alt-a: Determination based on the content in the scheduling downlink control information (DCI); and
Alt-b: Determination based on the rules applied for an UL transmission.

In a semi-static channel access mode, cross-FFP scheduling, for example, is a scheduling operation where a gNB can use a DCI to schedule UL transmission(s) in a later gNB's FFP period that is different from the gNB's FFP period that carries the scheduling DCI. In addition to intra-FFP scheduling, cross-FFP scheduling is under investigation. A gNB's FFP period is referred to as g-FFP. The cross-FFP scheduling has pending technical issues including whether and how to process a case where a gNB schedules an UL transmission in the later g-FFP.

Hence, a semi-static channel access method to support cross-FFP scheduling is desired.

### Technical Solution

An object of the present disclosure is to propose a user equipment, a base station, and a semi-static channel access method in an unlicensed band.

In a first aspect, an embodiment of the invention provides a semi-static channel access method executable in a user equipment (UE), comprising:
receiving a first downlink control information (DCI) within a fixed frame period (FFP), wherein the first DCI is for scheduling uplink (UL) transmissions over one or more FFPs;
deriving, for each scheduled UL transmission of the scheduled UL transmissions, a channel occupancy time (COT) initiator of the scheduled UL transmission;
determining one or more transmission symbols for each of the scheduled UL transmissions according to the derived COT initiator; and
transmitting each of the scheduled UL transmissions in the one or more transmission symbols of the one or more FFPs.

In a second aspect, an embodiment of the invention provides a user equipment (UE) comprising a processor configured to call and run a computer program stored in a memory, to cause a device in which the processor is installed to execute the disclosed method.

In a third aspect, an embodiment of the invention provides a semi-static channel access method executable in a base station, comprising:
transmitting a first downlink control information (DCI) within a fixed frame period (FFP), wherein the first DCI is for scheduling a plurality of uplink (UL) transmissions over one or more FFPs; and
receiving each of scheduled UL transmissions in one or more transmission symbols of one or more FFPs;
wherein the one or more transmission symbols for each scheduled UL transmission of the scheduled UL transmissions are determined according to a channel occupancy time (COT) initiator for the scheduled UL transmission.

In a fourth aspect, an embodiment of the invention provides a base station comprising a processor configured to call and run a computer program stored in a memory, to cause a device in which the processor is installed to execute the disclosed method.

The disclosed method may be programmed as computer executable instructions stored in non-transitory computer-readable medium. The non-transitory computer-readable medium, when loaded to a computer, directs a processor of the computer to execute the disclosed method.

The non-transitory computer-readable medium may comprise at least one from a group consisting of: a hard disk, a CD-ROM, an optical storage device, a magnetic storage device, a Read-Only Memory, a Programmable Read-Only Memory, an Erasable Programmable Read-Only Memory, EPROM, an Electrically Erasable Programmable Read-Only Memory and a Flash memory.

The disclosed method may be programmed as a computer program product that causes a computer to execute the disclosed method.

The disclosed method may be programmed as a computer program, that causes a computer to execute the disclosed method.

### Advantageous Effects

At least some embodiments of the invention address issues of control information necessary for semi-static channel access in both DL and UL cases. Embodiments of the disclosure include DCI contents for FFP scheduling, initiator determination in the absence of an initiator indication field, mechanisms to overwrite or switch initiator before or during a UL transmission, and PDSCH/PUSCH repetition schemes across FFP boundaries. PDSCH stands for physical downlink shared channel (PDSCH). PUSCH stands for physical uplink shared channel (PUSCH).
At least one embodiment of the invention provides procedures and schemes to support UE-initiated or gNB-initiated FFP scheduling, wherein the contents of DCI are proposed for flexible scheduling and enhanced resource efficiency.
At least one embodiment of the invention provides procedures and schemes to support various conditions regarding COT initiator determination, such as COT initiator indication, UE's assumptions on COT initiator in the absence of a COT initiator indication, overwriting or switching an original indicated COT initiator.
At least one embodiment of the invention provides procedures and schemes to support cross-FFP UL and DL channel repetitions.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skills in this field may obtain other figures according to these figures without paying the premise.

FIG. 1 illustrates a schematic view of a telecommunication system.

FIG. 2 illustrates a schematic view showing a semi-static channel access method according to an embodiment of the invention.

FIG. 3 illustrates a schematic view showing a semi-static channel access method according to another embodiment of the invention.

FIG. 4 illustrates a schematic view showing an embodiment of a semi-static channel access method in unlicensed band.

FIG. 5 illustrates a schematic view showing another embodiment of a semi-static channel access method in unlicensed band.

FIG. 6 illustrates a schematic view showing still another embodiment of a semi-static channel access method in unlicensed band.

FIG. 7 illustrates a schematic view showing an example of a procedure for triggering UE-initiated COT.

FIG. 8 illustrates a schematic view showing an example of a procedure for uplink transmission overlapping with an idle period.

FIG. 9 illustrates a schematic view showing an example procedure for determining a COT initiator.

FIG. 10 illustrates a schematic view showing an example of overwriting an original initiator indication in DCI.

FIG. 11 illustrates a schematic view showing an example procedure of COT initiator overwriting.

FIG. 12 illustrates a schematic view showing an example of COT initiator switching.

FIG. 13 illustrates a schematic view showing an example procedure of modifying or switching a COT initiator.

FIG. 14 illustrates a schematic view showing an example of slot-based cross-FFP UL scheduling for PDSCH repetition.

FIG. 15 illustrates a schematic view showing an example of non-slot-based cross-FFP UL scheduling for PDSCH repetition.

FIG. 16 illustrates a schematic view showing an example of lot-based cross-FFP UL scheduling for PUSCH repetition in UE-initiated COTs.

FIG. 17 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Embodiments of the invention address the issues of cross-FFP scheduling for both DL and UL cases, such as cross-FFP scheduling indication, determination of UL and DL scheduling based on gNB-initiated or UE-initiated COT, DL/UL cancellation scheme, etc.

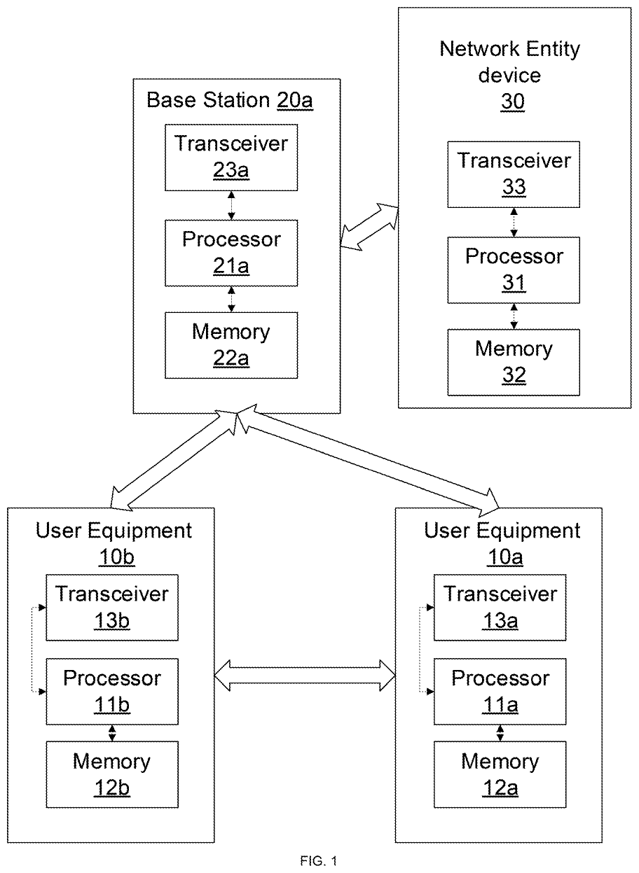

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative, not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Uplink (UL) transmission of a control signal or data may be a transmission operation from a UE to a base station. Downlink (DL) transmission of a control signal or data may be a transmission operation from a base station to a UE. In the following description, unless elsewhere specified, a UE can be interpreted as an embodiment of the UE 10, and a gNB or a base station can be interpreted as an embodiment of the gNB 20.

In the description, unless being specifically pointed out, an initiator is a COT initiator, an indication or an initiator indication is a COT initiator indication.

In the description, for simplicity, a COT initiated by a base station is referred to as a gNB-initiated COT, a BS-initiated COT, or a gNB's COT. A COT initiated by a UE is referred to as a UE-initiated COT or a UE's COT. In the description, unless being specifically pointed out, a gNB-initiated COT may be a COT initiated by a base station, such as gNB 20, according to an embodiment of the disclosure; a UE-initiated COT may be a COT initiated by a UE, such as the UE 10, according to an embodiment of the disclosure; a gNB's FFP referred to as g-FFP is an FFP according to a set of FFP parameters associated with a base station, such as the gNB 20, according to an embodiment of the disclosure; and a UE's FFP referred to as u-FFP is an FFP according to a set of FFP parameters associated with a UE, such as the UE 10, according to an embodiment of the disclosure. The parameter may comprise a COT initiator.

A scheme of initiating a COT by a base station is referred to as a gNB-initiated COT scheme or gNB-initiated COT function, and a scheme of initiating a COT by a UE is referred to as a UE-initiated COT scheme or UE-initiated COT function. For simplicity, the scheme of gNB-initiated COT may be referred to as gNB-initiated COT, and the scheme of UE-initiated COT may be referred to as UE-initiated COT.

In the description, PUSCH transmission means transmission performed by a UE, such as the UE 10, for PUSCH(s) scheduled by DCI. DCI that schedules PUSCH(s) is referred to as scheduling DCI. In the description, PUSCH scheduled for PUSCH transmission may comprise one or more PUSCHs. In the description, PDSCH transmission means transmission from a gNB, such as the gNB 20, to a UE, such as UE 10, for PDSCH(s) scheduled by DCI. DCI that schedules PDSCH(s) is referred to as scheduling DCI. PDSCH scheduled for PDSCH transmission may comprise one or more PDSCHs.

In the description, the term of “UL channel” means a UL channel in the unlicensed band, and the term of “DL channel” means a DL channel in the unlicensed band. To sense or detect a channel means to sense or detect a channel in the unlicensed band. To access a channel means to access a channel in the unlicensed band. The terms “channel access method”, “channel access mode”, and “channel access scheme” means a channel access method, channel access mode, and channel access scheme for a channel in the unlicensed band. Embodiments of the disclosure are detailed in the following.

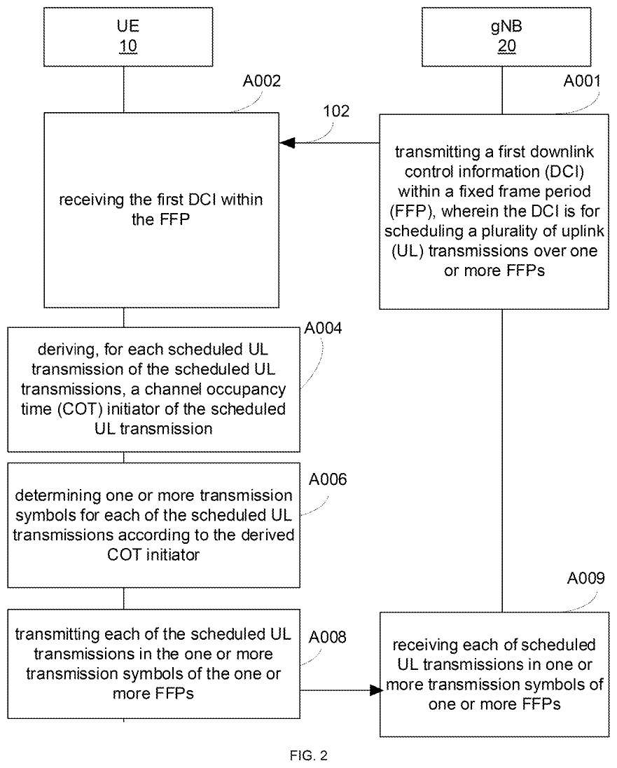

With reference to FIG. 2, the gNB 20 executes a semi-static channel access method in an unlicensed spectrum. The gNB 20 transmits a first downlink control information (DCI) 102 within a fixed frame period (FFP), wherein the first DCI 102 is for scheduling a plurality of uplink (UL) transmissions over one or more FFPs (A001).

The UE 10 executes the semi-static channel access method in the unlicensed spectrum. The UE 10 receives the first DCI 102 within the FFP, wherein the first DCI 102 is for scheduling the UL transmissions over the one or more FFPs (A002).

The UE 10 derives, for each scheduled UL transmission of the scheduled UL transmissions, a channel occupancy time (COT) initiator of the scheduled UL transmission (A004).

The UE 10 determines one or more transmission symbols for each of the scheduled UL transmissions according to the derived COT initiator (A006).

The UE 10 transmits each of the scheduled UL transmissions in the one or more transmission symbols of the one or more FFPs (A008).

The gNB 20 receives each of scheduled UL transmissions in one or more transmission symbols of one or more FFPs (A009). The one or more transmission symbols for each scheduled UL transmission of the scheduled UL transmissions are determined according to the COT initiator for the scheduled UL transmission.

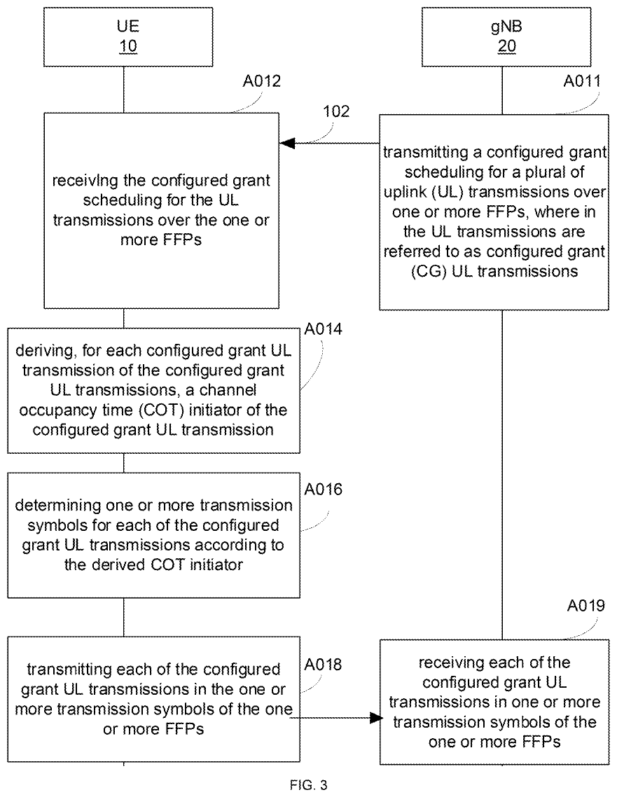

With reference to FIG. 3, the gNB 20 executes a semi-static channel access method in an unlicensed spectrum. The gNB 20 transmits a configured grant scheduling for multiple uplink (UL) transmissions over one or more fixed frame periods (FFPs), wherein the UL transmissions are referred to as configured grant (CG) UL transmissions (A011).

The UE 10 executes the semi-static channel access method in the unlicensed spectrum. The UE 10 receives the configured grant scheduling for the UL transmissions over the one or more FFPs (A012).

The UE 10 derives, for each configured grant UL transmission of the configured grant UL transmissions, a channel occupancy time (COT) initiator of the configured grant UL transmission (A014).

The UE 10 determines one or more transmission symbols for each of the configured grant UL transmissions according to the derived COT initiator (A016).

The UE 10 transmits each of the configured grant UL transmissions in the one or more transmission symbols of the one or more FFPs (A018).

The gNB 20 receives each of configured grant UL transmissions in one or more transmission symbols of one or more FFPs (A019). The one or more transmission symbols for each configured grant UL transmission of the configured grant UL transmissions are determined according to the COT initiator for the configured grant UL transmission.

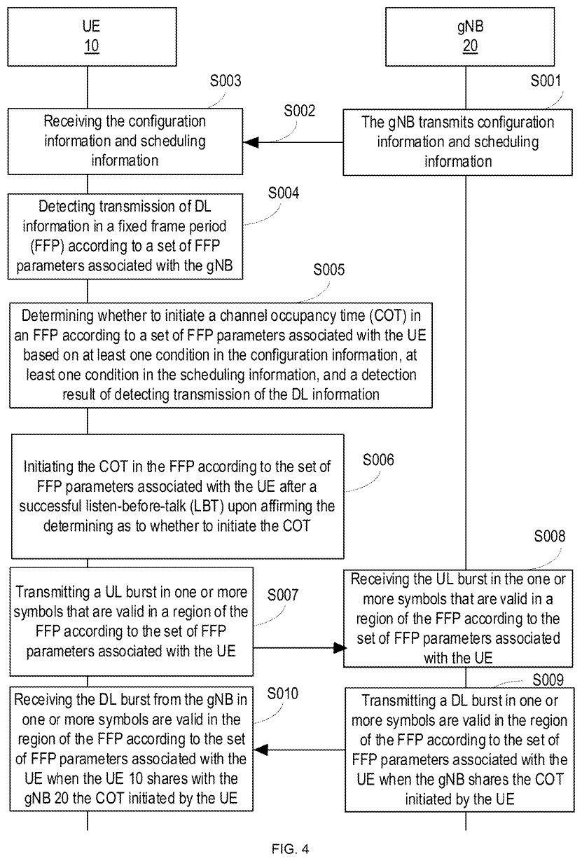

In the FIG. 4, the UE 10 and the gNB 20 execute an embodiment of a semi-static channel access method in an unlicensed band. The embodiment is suitable for CG UL transmission in unlicensed band(s). The gNB 20 determines (S001) and transmits (S002) configuration information and scheduling information to the one or more UE (e.g., the UE 10). The UE 10 receives the configuration information and scheduling information from the gNB 20 (S003) and detects transmission of downlink (DL) information in a fixed frame period (FFP) according to a set of FFP parameters associated with the gNB 20 (S004).

The UE 10 determines whether to initiate a channel occupancy time (COT) in an FFP according to a set of FFP parameters associated with the UE 10 based on at least one condition in the configuration information, at least one condition in the scheduling information, and a detection result of detecting transmission of the DL information (S005).

The UE 10 initiates the COT in the FFP according to the set of FFP parameters associated with the UE 10 after a successful listen-before-talk (LBT) upon affirming the determining as to whether to initiate the COT (S006).

The UE 10 transmits to the gNB 20 a UL burst in one or more symbols that are valid in a region of the FFP according to the set of FFP parameters associated with the UE 10 (S007). The gNB 20 receives the UL burst in the one or more symbols that are valid in a region of the FFP according to the set of FFP parameters associated with the UE 10 (S008). The UL burst may comprise transmission of physical uplink shared channel (PUSCH), physical uplink control channel (PUCCH), or repetitive transmission of the PUSCH or the PUCCH. The repetitive transmission of the PUSCH may comprise repetitions of the PUSCH in PUSCH repetition type A or type B.

The gNB 20 transmits to the UE 10 a DL burst in one or more symbols are valid in the region of the FFP according to the set of FFP parameters associated with the UE 10 when the gNB 20 shares the COT initiated by the UE 10 (S009). The UE 10 receives the DL burst from the gNB 20 in one or more symbols are valid in the region of the FFP according to the set of FFP parameters associated with the UE 10 when the UE 10 shares with the gNB 20 the COT initiated by the UE 10 (S010). For example, the DL burst may include Msg2, Msg4 or PDCCH for Msg3 retransmission.

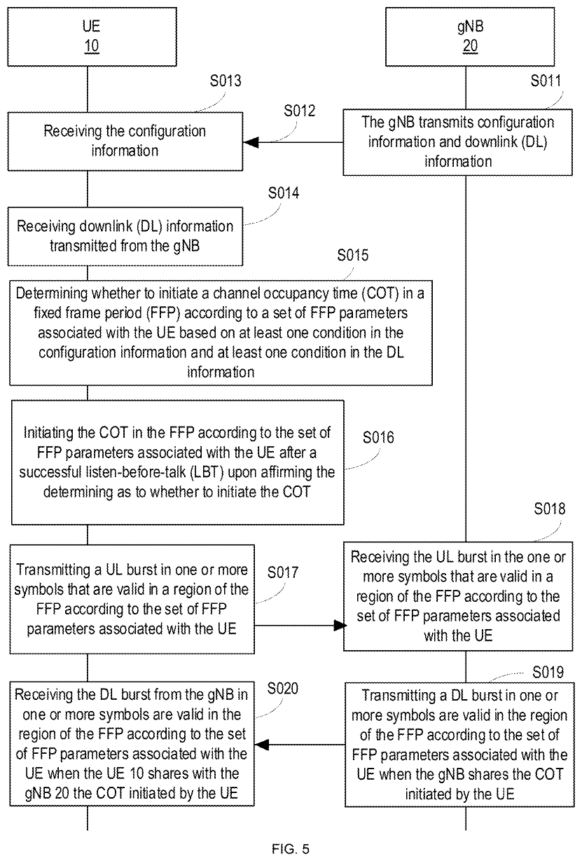

In the FIG. 5, the UE 10 and the gNB 20 execute an embodiment of a semi-static channel access method in unlicensed band. The embodiment is suitable for DG UL transmission in unlicensed band(s). The gNB 20 generates (S011) and transmits (S012) configuration information to the one or more UE (e.g., the UE 10) and transmits downlink (DL) information to the UE 10 (S012). The UE 10 receives the configuration information transmitted from a gNB 20 (S013) and receives the DL information transmitted from the gNB 20 (S014).

The UE 10 determines whether to initiate a channel occupancy time (COT) in a fixed frame period (FFP) according to a set of FFP parameters associated with the UE 10 based on at least one condition in the configuration information and at least one condition in the DL information (S015). The UE 10 initiates a COT in the FFP according to the set of FFP parameters associated with the UE 10 after a successful listen-before-talk (LBT) upon affirming the determining as to whether to initiate the COT (S016).

The UE 10 transmits to the gNB 20 an UL burst to the gNB 20 in one or more symbols that are valid in a region of the FFP according to the set of FFP parameters associated with the UE 10 (S017). The gNB 20 receives the UL burst in the one or more symbols that are valid in a region of the FFP according to the set of FFP parameters associated with the UE 10 (S018). The UL burst may comprise transmission of physical uplink shared channel (PUSCH), physical uplink control channel (PUCCH) or repetitive transmission of the PUSCH or the PUCCH. The repetitive transmission of the PUSCH may comprise repetitions of the PUSCH in PUSCH repetition type A or type B.

The gNB 20 transmits to the UE 10 a DL burst in one or more symbols are valid in the region of the FFP according to the set of FFP parameters associated with the UE 10 when the gNB 20 shares the COT initiated by the UE 10 (S019). The UE 10 receives a DL burst from the gNB 20 in one or more symbols that are valid in the region of the FFP according to the set of FFP parameters associated with the UE 10 when the UE 10 shares with the gNB 20 the COT initiated by the UE 10 (S020). For example, the DL burst may include Msg2, Msg4 or PDCCH for Msg3 retransmission.

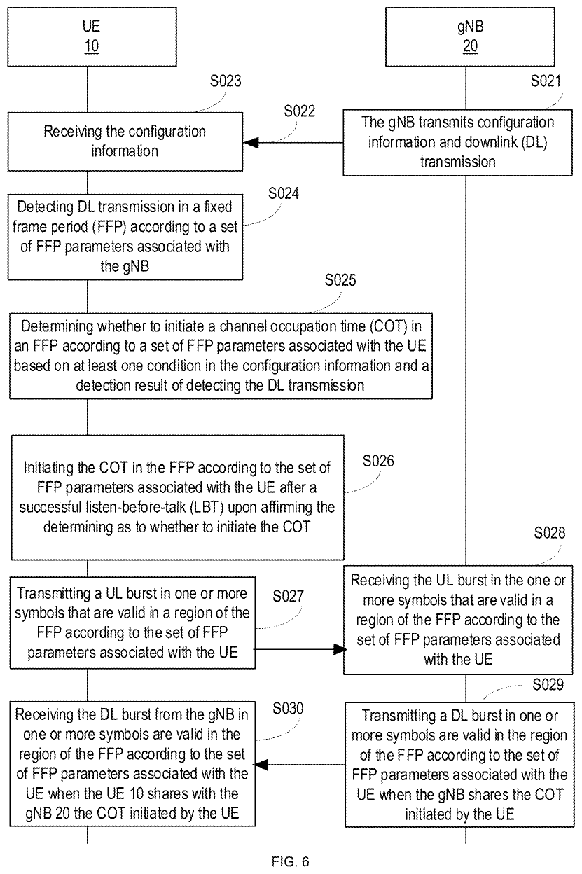

In the FIG. 6, the UE 10 and the gNB 20 execute an embodiment of a semi-static channel access method in an unlicensed band. The gNB 20 generates (S021) and transmits (S022) configuration information to the one or more UE (e.g., the UE 10) and transmits downlink (DL) information to the UE 10 (S022). The UE 10 receives the configuration information transmitted from a gNB 20 (S023) and detects a downlink (DL) transmission in a fixed frame period (FFP) according to a set of FFP parameters associated with the gNB 20 (S024).

The UE 10 determines whether to initiate a channel occupation time (COT) in an FFP according to a set of FFP parameters associated with the UE 10 based on at least one condition in the configuration information and a detection result of detecting the DL transmission (S025).

The UE 10 initiates a COT in the FFP according to the set of FFP parameters associated with the UE 10 after a successful listen-before-talk (LBT) upon affirming the determining as to whether to initiate the COT (S026). The UE 10 transmits to the gNB 20 an uplink (UL) burst in one or more symbols that are valid in a region of the FFP according to the set of FFP parameters associated with the UE 10 (S027). The gNB 20 receives the UL burst in the one or more symbols that are valid in a region of the FFP according to the set of FFP parameters associated with the UE 10 (S028). The UL burst may comprise transmission of physical uplink shared channel (PUSCH), physical uplink control channel (PUCCH), or repetitive transmission of the PUSCH or the PUCCH. The repetitive transmission of the PUSCH may comprise repetitions of the PUSCH in PUSCH repetition type A or type B.

The gNB 20 transmits to the UE 10 a DL burst in one or more symbols are valid in the region of the FFP according to the set of FFP parameters associated with the UE 10 when the gNB 20 shares the COT initiated by the UE 10 (S029). The UE 10 receives a DL burst from the gNB 20 in one or more symbols that are valid in the region of the FFP according to the set of FFP parameters associated with the UE 10 when UE 10 shares with the gNB 20 the COT initiated by the UE 10 (S030). For example, the DL burst may include Msg2, Msg4 or PDCCH for Msg3 retransmission.

### ▪ Embodiment A3: Indication of UE-Initiated COT to UE

In addition to detection of the presence of a gNB-initiated COT shared by the gNB 20 based on DL channel(s)/signal(s), the gNB 20 can explicitly or implicitly indicate the UE 10 one or more types of information for UE 10 to determine whether or not to initiate a COT for UL transmission in at least one of the following FFPs.

### ▪ Embodiment A3-1: Information Provided by gNB Regarding UE-Initiated COT

The gNB 20 can indicate the UE 10 explicitly or implicitly at least one of the following information:
COT type related capability: The capability information indicates whether UE-initiated COT is allowed.
COT sharing information: If UE-initiated COT is allowed, the UE 10 may receive the COT sharing information and determine whether or not the UE 10 can still use shared COT from the gNB 20 in case the UE 10 fails LBT in a UE-initiated COT.
COT type information: The COT type information indicates whether the DL transmission is transmitted according to a gNB-initiated COT of the gNB 20 or is transmitted according to a UE-initiated COT which is shared by the gNB 20 from one of the other UEs.
COT prioritization information: The COT prioritization information specifies which one of the FFP configurations is prioritized over other FFPs based on gNB's configuration, and/or associated FFP parameters for each of FFP configurations. UE-initiated COT should follow the FFP configuration specified in the COT prioritization information if more than one FFP configurations are configured for the UE 10.
COT location information: The COT location information provides locations of a number of subsequent FFPs that allow UE to perform UE-initiated COT. For example, the COT location information comprises a bitmap pattern to indicate the UE 10 location(s) of one or more FFPs that allows initiation of UE-initiated COT(s).

### Embodiment A3-2: Priority or QoS Related Information for Triggering UE-Initiated COT

The UE 10 can determine whether a UE-initiated COT or a shared gNB-initiated COT is used for UL transmission based on priority levels of UL traffic types or performance-related information of UL traffic types, which is detailed in the following:

### Priority Levels of UL Traffic Types:

The priority levels of UL traffic types may be physical layer priority levels or medium access control (MAC) layer priority levels:
[symbol] Physical layer priority level: Examples of the physical layer priority levels may comprise one or more of:
   ♦ Priority levels indicated in CG configuration;
   ♦ Priority levels indicated in uplink grant DCI;
   ♦ HARQ codebook priority for HARQ feedback; and
   ♦ Channel access priority classes (CAPCs).
[symbol] MAC layer priority level: Examples of the MAC layer priority levels may comprise one or more of:
   ♦ LCG (logic channel group) priority levels for triggering scheduling request(s); and
   ♦ Logical Channel Prioritization (LCP) restrictions to prioritize grant resources for URLLC.

### Performance-Related Information:

The performance-related information, for example, may comprise quality of service (Qos) or a latency requirement of serving traffic types and may be obtained from via time-sensitive network (TSC) assistance information (TSCAI).

### Embodiment A3-3: Resource Location Related Information for Triggering UE-Initiated COT

In an embodiment, the UE derives the COT initiator for each configured grant UL transmission of the configured grant UL transmissions according to a rule used for configured grant (CG) based COT initiator determination. Examples of the rule are illustrated in the following.

In an embodiment, for configured grant (CG) based UL scheduling, the scheduling information includes a location of a UL resource for configured grant UL transmission. For dynamic grant (DG) based scheduling, the DCI in PDCCH includes a location of a UL resource for dynamic grant UL transmission. The UE 10 can determine whether UE-initiated COT or shared gNB-initiated COT is used for UL transmission based on the resource location of CG or DG resource(s) in relation to the location of a UE's FFP or a gNB's FFP.

For the case that a CG or DG uplink resource starts at the starting point of a UE's FFP and ends before the idle period of UE's FFP, the following schemes can be used to determine whether the UE 10 initiated COT or the gNB 20 initiated the COT is used for UL transmission:
UE-initiated COT is assumed, the UE 10 can perform LBT immediately before a UE's COT in order to initiate the UE's COT.
The UE 10 determines either UE-initiated COT or gNB-initiated COT is applied (or activated) according to an indication from the gNB 20. The indication may be carried in RRC signaling or dynamic DCI. In an embodiment, the DCI further includes COT-initiator information, the COT-initiator information indicates whether the dynamically scheduled UL transmission is based on UE-initiated COT or based on base-station-initiated COT. In an embodiment, the configuration information in FIG. 4 to FIG. 6 further includes an indication showing that the UE is allowed to perform a UE-initiated COT function. The configuration information may be transmitted in RRC signaling. In an embodiment, the configuration information FIG. 4 to FIG. 6 further includes an indication showing that the UE (e.g., UE 10) is allowed to perform a UE-initiated COT function.
The UE 10 can determine which COT type is applied based on a predefined decision rule which may be a rule shared or not shared between the UE 10 and gNB 20.
   [symbol] COT type determination at UE with decision rule(s) shared with the gNB 20: For example, according to a decision rule, the UE 10 selects a COT type whose idle period does not overlap with the CG or DG uplink resource. In another example, the UE 10 selects a COT type according to a priority level of the uplink traffic.
   [symbol] COT type determination at UE with decision rule(s) not shared with the gNB 20: For example, the UE 10 can autonomously decide a COT type. However, since the decision rule is not known to the gNB 20, the UE 10 can notify the gNB 20 of the selected COT type via an uplink signal (e.g., CG-UCI) over an uplink channel.

For the case that the CG or DG uplink resource does not start at the starting point of the UE's FFP UE, gNB-initiated COT is assumed, and the UE 10 can share gNB-initiated COT for uplink transmission.

For the case that the DG uplink resource is located outside of the gNB's current COT (e.g., the uplink resource scheduled in a COT of the gNB 20 which is different from the COT of the gNB 20 used for transmission of dynamic grant scheduling), UE-initiated COT is assumed.

For the case that the CG or DG uplink resource is located within both of the gNB′ COT and the UE's COT, the COT type can be determined based on the following schemes:

### Scheme 1:

In an embodiment, the DL information in FIG. 4 and FIG. 5, is derived from a DL channel or a DL signal, which is transmitted at a starting point of an FFP according to a set of FFP parameters associated with the base station. The transmitted DL channel may include a PDCCH. DCI in the PDCCH may include resource location information for dynamically scheduled UL transmission from the UE.

If the UE 10 has detected DL channels/signals at the front portion of the gNB's FFP and/or the gNB 20 has indicated UE-initiated COT is not allowed, gNB-initiated COT is assumed for UL transmission.

Otherwise, if the uplink resource starts at the starting point of UE's FFP and/or the gNB 20 has indicated that UE-initiated COT is allowed, and/or the UE (e.g., the UE 10) has initiated a COT, UE-initiated COT is assumed for UL transmission.

### Scheme 2:

If the uplink resource starts at the starting point of UE's FFP and/or the gNB 20 has indicated that UE-initiated COT is allowed, and/or the UE 10 has initiated a COT, UE-initiated COT is assumed for UL transmission.

Otherwise, if the UE 10 has detected DL channels/signals at the front portion of gNB's FFP and/or the gNB 20 has indicated UE-initiated COT is not allowed, gNB-initiated COT is assumed for UL transmission.

In an embodiment, in the FIG. 4, at least one condition in the configuration information, at least one condition in the scheduling information, and the detection result of detecting transmission of the DL information comprise at least one of the following:
[symbol] the configuration information comprises at least one set of FFP parameters associated with the UE or an indication showing that a UE-initiated COT function is allowed;
[symbol] the scheduling information includes UL resource location information for configured grant UL transmission in the UL burst, the UL resource location information indicates a location of a UL resource for the configured grant UL transmission, a starting location of the UL resource for the configured grant UL transmission is aligned with a starting point of the FFP according to the set of FFP parameters associated with the UE; and
[symbol] the UL resource for the configured grant UL transmission in the scheduling information is located within a COT of the FFP according to the set of FFP parameters associated with the base station, and the UE does not detect DL information from a starting point of the FFP according to the set of FFP parameters associated with the base station.

In an embodiment, in the FIG. 5, the at least one condition in the configuration information and the at least one condition in the DL information comprise at least one of the following:
[symbol] the configuration information comprises at least one set of FFP parameters associated with the UE or an indication showing that a UE-initiated COT function is allowed; and
[symbol] a DCI in the DL information includes resource location information and COT-initiator information for dynamically scheduled UL transmission, the resource location information indicates a location of a UL resource scheduled for the dynamically scheduled UL transmission, and the COT-initiator information indicates that the dynamically scheduled UL transmission is based on a UE-initiated COT.

In an embodiment, in the FIG. 5, the at least one condition in the configuration information and the at least one condition in the DL information for comprise at least one of the following:
[symbol] the configuration information comprises at least one set of FFP parameters associated with the UE or an indication showing that a UE-initiated COT function is allowed;
[symbol] the UE receives the DL information, but the DL information is not transmitted from a starting point of an FFP according to a set of FFP parameters associated with the base station; and
[symbol] a DCI in the DL information includes resource location information for dynamically scheduled UL transmission in the UL burst, the resource location information indicates a location of a UL resource scheduled for the dynamically scheduled UL transmission, and a starting location of the dynamically scheduled UL transmission is aligned with a starting point of the FFP according to the set of FFP parameters associated with the UE.

In an embodiment, in the FIG. 5, the at least one condition in the configuration information and the at least one condition in the DL information comprise at least one of the following:
[symbol] the configuration information comprises at least one set of FFP parameters associated with the UE or an indication showing that a UE-initiated COT function is allowed; and
[symbol] the UE receives the DL information in an FFP according to a set of FFP parameters associated with the base station, a DCI in the DL information includes resource location information for dynamically scheduled UL transmission, the resource location information indicates a location of a UL resource scheduled for the dynamically scheduled UL transmission in the UL burst, the UL resource scheduled for the dynamically scheduled UL transmission is located in a later FFP outside of a base-station-associated FFP scheduling the dynamically scheduled UL transmission, and a starting location of the dynamically scheduled UL transmission is aligned with a starting point of the FFP according to the set of FFP parameters associated with the UE.

In an embodiment, in the FIG. 5, wherein the at least one condition in the configuration information and the at least one condition in the DL information comprise at least one of the following:
[symbol] the configuration information comprises at least one set of FFP parameters associated with the UE or an indication showing that a UE-initiated COT function is allowed; and
[symbol] the UE receives the DL information in an FFP according to a set of FFP parameters associated with the base station, a DCI in the DL information includes resource location information and a COT-initiator information for dynamically scheduled UL transmission, the resource location information indicates a location of a UL resource scheduled for the dynamically scheduled UL transmission in the UL burst, the UL resource scheduled for the dynamically scheduled UL transmission is located in a later FFP outside of a base-station-associated FFP scheduling the dynamically scheduled UL transmission, and the COT-initiator information indicates that the dynamically scheduled UL transmission is based on a UE-initiated COT.

### Embodiment A3-3-1: An Example of a Procedure for Triggering UE-Initiated COT Based on Scheme 1 of Embodiment A3-3

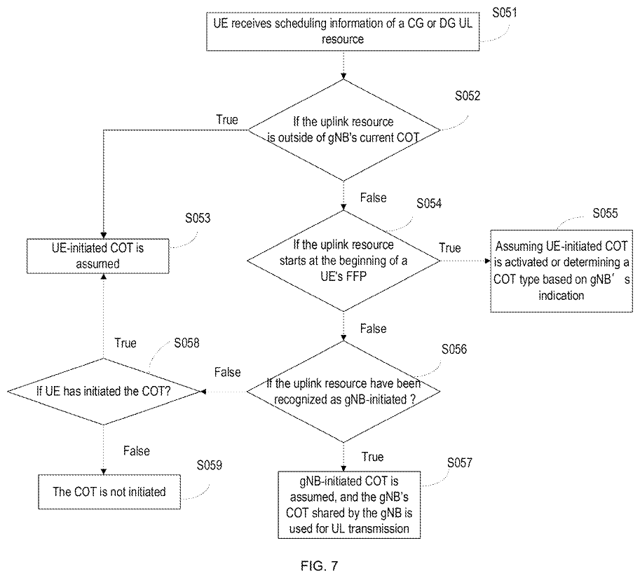

With reference to FIG. 7, the UE 10 receives scheduling information of a CG or DG uplink resource (S051) and determines if the uplink resource is located outside of a current COT of the gNB 20, referred to as gNB's current COT (S052). If the uplink resource is located outside of the current COT of the gNB 20, UE-initiated COT is assumed for UL transmission (S053).

If the uplink resource is located within both of the gNB's COT and the UE's COT, the UE 10 determines if the uplink resource starts at the starting point of a UEs' FFP (S054).

If the uplink resource starts at the starting point of the UEs' FFP (S054), the UE 10 assumes UE-initiated COT is activated or determines a COT type based on gNB's indication (S055).

If the uplink resource does not start at the starting point of the UEs' FFP (S054), the UE 10 determines whether the uplink resource of a COT to be initiated is a gNB-initiated COT (S056). For example, the UE 10 may determine whether the location of the uplink resource is a gNB-initiated COT or a UE-initiated COT based on DL channel/signal detection or based on an indication from the gNB 20. In an embodiment, in FIG. 4, the DL information (e.g., DL channel/signal detection) is derived from a DL channel or a DL signal transmitted at a starting point of the FFP according to a set of FFP parameters associated with the base station for UE to determine whether the gNB 20 has initiated a gNB's COT.

If the location for uplink transmission has been recognized as a gNB-initiated COT (S056), gNB-initiated COT is assumed, and the gNB's COT shared by the gNB 20 is used for UL transmission (S057).

If the location for uplink transmission is not recognized as a gNB-initiated COT, the UE 10 determines whether the location for uplink transmission in the COT has been initiated by the UE 10 (S058). If the location for uplink transmission in the COT has been initiated by the UE 10 (S058), UE-initiated COT is used for UL transmission (S053). Otherwise, the COT is not initiated (S059)

### Embodiment A3-4: RRC State Information for Triggering UE-Initiated COT

The UE 10 can determine whether UE-initiated COT or shared gNB-initiated COT is used for UL transmission based on an RRC state of the UE 10. The RRC state of the UE 10 may comprise one of RRC_IDLE state, RRC_INACTIVE state or RRC_CONNECTED state. In an embodiment, in the FIG. 4, the at least one condition in the configuration information, at least one condition in the scheduling information, and the detection result of detecting transmission of the DL information further comprise a condition that the UE is operated in an RRC_CONNECTED state.

For example, when the UE 10 in an RRC_IDLE state or RRC_inactive state, gNB-initiated COT is applied. When the UE 10 in an RRC_connected state, UE-initiated COT is assumed.

### Embodiment A3-5: Uplink Resource Availability for Triggering UE-Initiated COT

In an embodiment, in the FIG. 4, the at least one condition in the configuration information, at least one condition in the scheduling information, and the detection result of detecting transmission of the DL information further comprise a condition that the UL resource is a valid UL resource for performing COT initiation by the UE. The UL resource is a valid UL resource for performing COT initiation by the UE if symbols within the UL resource satisfy at least one of the following conditions:
[symbol] symbols in the UL resource are not indicated as DL symbols by the base station; and
[symbol] symbols in the UL resource are not cancelled by the base station.

In an embodiment, one or more valid symbols for transmission of the UL burst are defined as at least one of the following:
[symbol] symbols intended for UL transmission are not located within an idle period of the FFP where UE initiates the COT;
[symbol] symbols intended for UL transmission are not indicated as DL symbols in a slot format indication (SFI); and
[symbol] symbols intended for UL transmission are not cancelled by the base station.

The UE 10 can determine whether UE-initiated COT or shared gNB-initiated COT is used for UL transmission based on the availability of CG or DG uplink resource(s) at the beginning of a UE's FFP. If an uplink resource is available at the beginning of a UE's FFP, UE-initiated COT is assumed. If an uplink resource is not available at the beginning of a UE's FFP, gNB-initiated COT is assumed. In an embodiment, a starting location of dynamically scheduled UL transmission is aligned with a starting point of the FFP according to the set of FFP parameters associated with the UE.

The gNB 20 can configure the availability of CG or DG uplink resource(s) for UE-initiated COT using one or more of the following schemes:
Using group-common DCI (GC-DCI) to indicate the availability of CG or DG uplink resource(s) based on one of following indications:
   [symbol] Slot format indication (SFI) in DCI format 2_0.
      ♦ The gNB 20 can disable UE-initiated COT if the uplink resource for UL transmission at the beginning of UE's FFP is not valid.
   [symbol] Uplink cancellation indication (CI) in DCI format 2_4.
      ♦ The gNB 20 can disable UE-initiated COT if UL transmission at the beginning of the UE's FFP is canceled.
   [symbol] Other newly created indications in GC-DCI.

### Embodiment A3-6: Explicit Indication Scheme for Triggering UE-Initiated COT

The gNB 20 can explicitly indicate the UE-initiated COT using any one or any combinations of the following schemes:
RRC configuration indicating support of a COT type for a single FFP or triggering of a COT type for single FFP:

The gNB 20 can use new RRC configuration to indicate a COT type for a single FFP. For example, for the UE 10 having higher priority traffic, UE-initiated COT is configured; otherwise, gNB-initiated COT is configured.

The gNB 20 can reuse an existing RRC configuration, i.e., CG configuration, and add an additional field to indicate that the UE-initiated COT is supported. In an embodiment, the COT-initiator information is jointly encoded in an existing field used for load-based equipment (LBE) in dynamic channel access.
RRC configuration indicating COT type(s) for multiple FFPs:

The gNB 20 can use RRC configuration to indicate COT type(s) for a multiple FFP. For example, the gNB 20 uses bitmap as an indication of COT types for more than one upcoming FFPs. Each bit value of 1 or 0 in the bitmap can represent UE-initiated COT or gNB-initiated COT respectively. The gNB 20 can create a table with multiple row indices via RRC signaling, each index maps to one of multiple sets of bitmaps to indicate COT types of multiple FFPs. The gNB 20 can dynamically send DCI to the UE 10 to indicate a row index of the table to determine the selected bitmap of COT types.

### MAC CE:

The gNB 20 can use a newly created MAC CE or an existing MAC CE to indicate triggering of UE-initiated COT or gNB-initiated COT.
Dynamic DCI: The gNB 20 can use dynamic DCI to indicate triggering of UE-initiated COT or gNB-initiated COT, of which some examples are detailed in the following:
   [symbol] The gNB 20 can use an explicit parameter in DCI to indicate a COT Type. This parameter can be combined with the settings of FFP parameters.
   [symbol] For UL CG type 2 configuration, the gNB 20 can use activation DCI to indicate a COT type. In an embodiment, the COT-initiator information is located in an activation DCI used for scheduling Type 2 CG PUSCH transmission.
   [symbol] The gNB 20 can use group common DCI to allow a group of UEs to perform UE-initiated COT. For example, the gNB 20 can reuse the existing group common DCI format 2_0 to indicate a COT duration or SFI information. The COT-initiator information is located in a group common DCI for indicating a COT-initiator for a group of UEs.
   [symbol] The bit field used for indication of UE-initiated COT can be one of the following:
      ♦ An existing field for indication of LBT type for LBE;
      ♦ A specifically defined field, other than existing fields in the DCI;
      ♦ Any combination of more than one fields with a specific code point;
      ♦ A non-used field for FBE, which is borrowed from the LBE case; or
      ♦ The bit field jointly encoded with another bit field.

### Embodiment A3-7: Implicit Indication Scheme for Triggering UE-Initiated COT

The gNB 20 can implicitly indicate triggering (or activation) of the UE-initiated COT using any one or any combinations of the following schemes.

### Dynamic DCI:

The gNB 20 can use dynamic DCI to indicate triggering of UE-initiated COT or gNB-initiated COT. The bit field in DCI used for indication of UE-initiated COT can be an existing field for indication of an LBT type for LBE.
[symbol] For example, Type 2 LBT (i.e., no LBT) means that gNB-initiated COT is triggered since, in this case, PUSCH is transmitted within a shared gNB-initiated COT.
[symbol] For example, Type 1 LBT (i.e., CCA of 9 us) means UE-initiated COT requiring 9 us CCA is triggered since, in this case, PUSCH transmission is outside of a shared gNB-initiated COT.

### Uplink Resource Location:

The gNB 20 can use a location of a CG or DG uplink resource for UL transmission with respect to the location of a UE's FFP to indicate triggering of UE-initiated COT or gNB-initiated COT. For example, if the uplink resource starts at the beginning of UE's FFP, UE-initiated COT is assumed.

### Energy Detection (ED) Threshold Value:

The gNB 20 can use an ED threshold value to indicate triggering of UE-initiated COT or gNB-initiated COT. For example, if UE-initiated COT is preferred, the ED threshold value for LBT is set lower, and the UE 10 shares a UE-initiated COT to the gNB 20. For example, if gNB-initiated COT is preferred, the ED threshold value is set higher for ease of UL transmission.

### Embodiment A3-8: Overwriting Mechanisms for UE-Initiated COT Indication

The gNB 20 can send an overwriting indication of an updated COT type to the UE 10, thus overwriting a previous indication of a previous COT type. The previous indication of the previous COT type may be previously sent from the gNB 20 to the UE 10 or previously determined by the UE 10. In an embodiment, the COT-initiator information in the activation DCI overwrites the COT-initiator determination according to a decision rule used for CG UL transmission. Indication of a COT type can be overwritten with the following possible schemes:

Dynamic control information (e.g., DCI) with the overwriting indication of an updated COT type can overwrite the COT type previously configured by a higher-layer RRC signalling. For example, an indication of a COT type in dynamic DCI can overwrite a COT type configured in CG uplink transmission.

Dedicated RRC signalling with the overwriting indication of an updated COT type can overwrite the default setting of COT type, which may be, for example, configured by SIB1.

In an embodiment, the COT-initiator information in the DCI overwrites COT-initiator information in a previously received DCI. Group-common DCI with the overwriting indication of an updated COT type can overwrite a COT type based on a newly created DCI format or an existing DCI format. For example, the gNB 20 reuses existing group common DCI format 2_0 used for indicating COT duration or SFI information as the overwriting indication of an updated COT type to instantaneously overwrite the previously determined COT type.

In an embodiment, the base station transmits DCI, and the DCI includes a slot format indication (SFI) for at least one of the configured grant UL transmissions. The UE receives a DCI. The SFI indicated in the DCI cancels at least one of the configured grant UL transmissions.

In an embodiment, the base station transmits a second DCI later than the first DCI, and the second DCI includes a slot format indication (SFI) for at least one of the UL transmissions scheduled by the first DCI. The SFI indicated in the second DCI cancels at least one of the UL transmissions scheduled by the first DCI. The UE receives the second DCI later than the first DCI, and the second DCI includes a slot format indication (SFI) for at least one of the UL transmissions scheduled by the first DCI. The SFI indicated in the second DCI cancels at least one of the UL transmissions scheduled by the first DCI.

### Embodiment A5: UL Transmission Overlapping with an Idle Period

### Embodiment A5-1: UE-Initiated COT with UL Transmission Overlapping with an Idle Period

In an embodiment, in the FIG. 4 to FIG. 6, transmission of the UL burst in the FFP according to the set of FFP parameters associated with the UE includes repetitions of UL transmission, and when a nominal repetition in the repetitions coincides or overlaps with one or more invalid symbols, the nominal repetition is segmented into actual repetitions based on PUSCH repetition type B, or the nominal repetition is not transmitted.

In the description, segmentation of one or more nominal repetitions of TB(s) into actual repetitions of the TB(s) is referred to as segmentation. For UE-initiated COT in CG or DG, if any of the UL transmissions of single TB or repetitions of TB(s) is conflicted with an idle period of a UE's FFP or an idle period of a gNB's FFP, at least one of the following strategies can be adopted:
If the location of uplink resource collides with the idle period of UE's FFP, the UE 10 may perform one or more of the following procedures:
   [symbol] The UE 10 skip the transmission of the whole transport block (TB) as long as the TB is overlapped in part with the idle period.
   [symbol] The UE 10 treats symbols in idle periods as invalid symbols and performs segmentation by dividing nominal repetition of the TB into actual repetitions of the TB based on the similar scheme in type 2 repetition of Rel. 16 URLLC.
If the location of uplink resources collides with the idle period of the gNB's FFP, the UE 10 may perform one or more of the following procedures:
   [symbol] The UE 10 can still perform UL transmission the TB or repetitions of the TB over the idle period.
   [symbol] The UE 10 skips the UL transmission as long as it is overlapped in part with the idle period.
   [symbol] The UE 10 regards symbols in idle periods as invalid symbols and performs segmentation by dividing nominal repetition of the TB into actual repetitions of the TB based on the similar scheme in type 2 repetition of Rel. 16 URLLC.
   [symbol] In an embodiment, the gNB 20 transmits a gNB-controlled indication to the UE 10. Based on gNB controlled indication, the UE 10 determines UE's behavior regarding whether to perform UL transmission over an idle period of a gNB's FFP. The gNB-controlled indication may include one or more of the following:
      ♦ Dynamic unicast or group common indication;
      ♦ RRC configuration;
      ♦ Medium access control (MAC) control element (CE); and
      ♦ A predetermined rule.

For example, the predetermined rule may comprise a default setting, whereby the UE 10 determines UE's behavior regarding whether to perform UL transmission over an idle period of a gNB's FFP according to the default setting. The predetermined rule can be subject to be overwritten. In another example, the predetermined rule may comprise priority level information relevant to a specific traffic the UE 10 obtains from higher layer signaling.

### Embodiment A5-2: Sharing gNB-Initiated COT for UL Transmission Overlapping with an Idle Period

For the UE 10 sharing a gNB-initiated COT in CG or DG, if any of the UL transmissions of single TB or repetitions of TB(s) is conflicted with an idle period of a UE's FFP or an idle period of a gNB's FFP, at least one of the following strategies can be adopted:
If the location of an uplink resource collides with an idle period of UE's FFP, the UE 10 may ignore the idle period and still perform the UL transmissions of single TB or repetitions of TB(s) over the idle period.
If the uplink resources for the UL transmission collide with an idle period of the gNB's FFP, the UE 10 may perform one or more of the following procedures:
   [symbol] The UE 10 skip the transmission of the whole transport block (TB) as long as the TB is overlapped in part with the idle period.
   [symbol] The UE 10 treats symbols in idle periods as invalid symbols and performs segmentation by dividing nominal repetition of the TB into actual repetitions of the TB based on the similar scheme in type 2 repetition of Rel. 16 URLLC.
   [symbol] In an embodiment, the gNB 20 transmits a gNB-controlled indication to the UE 10. Based on gNB controlled indication, the UE 10 determines UE's behavior regarding whether to perform UL transmission over an idle period of a gNB's FFP. The gNB-controlled indication may include one or more of the following:
      ♦ Dynamic unicast or group common indication;
      ♦ RRC configuration;
      ♦ Medium access control (MAC) control element (CE); and
      ♦ A predetermined rule.

For example, the predetermined rule may comprise a default setting, whereby the UE 10 determines UE's behavior regarding whether to perform UL transmission over an idle period of a gNB's FFP according to the default setting. The predetermined rule can be subject to be overwritten. In another example, the predetermined rule may comprise priority level information relevant to a specific traffic the UE 10 obtains from higher layer signaling.

In an embodiment, the configured grant UL transmissions comprises repetitions of a PUSCH transmission for a single transport block. In an embodiment, the repetitions may be one or more nominal repetitions of a PUSCH transmission with repetition type B.

In an embodiment, the configured grant UL transmissions comprises multiple configured grant PUSCH transmissions, each of the multiple configured grant PUSCH transmissions carries a transport block.

In an embodiment, if the derived COT initiator is the UE, and if a nominal repetition among the one or more nominal repetitions overlaps with an idle period of a COT initiated by the UE, the UE determines one or more symbols of the nominal repetition without overlapping with the idle period as the one or more transmission symbols and segments the nominal repetition into one or more actual repetitions. For the base station receiving each of the configured grant UL transmissions in one or more transmission symbols of the one or more FFPs, one or more symbols of the nominal repetition without overlapping with the idle period constitute the one or more transmission symbols.

In an embodiment, if the derived COT initiator is a base station, and if a nominal repetition among the one or more nominal repetitions overlaps with an idle period of a COT initiated by the base station, the UE determines one or more symbols of the nominal repetition without overlapping with the idle period as the one or more transmission symbols and segments the nominal repetition into one or more actual repetitions. For the base station receiving each of the configured grant UL transmissions in one or more transmission symbols of the one or more FFPs, one or more symbols of the nominal repetition without overlapping with the idle period constitute the one or more transmission symbols.

In an embodiment, if the derived COT initiator is a base station and if a nominal repetition among the one or more nominal repetitions overlaps with an idle period of a COT initiated by the UE, all of one or more scheduled symbols within the nominal repetition are not transmitted, and all of one or more scheduled symbols within the nominal repetition are not received by the base station.

### Embodiment A5-2-1: An Example of a Procedure for Uplink Transmission Overlapping with an Idle Period

An idle period in a UE's FFP is referred to as a UE's idle period, and an idle period in a gNB's FFP is referred to as a gNB's idle period.

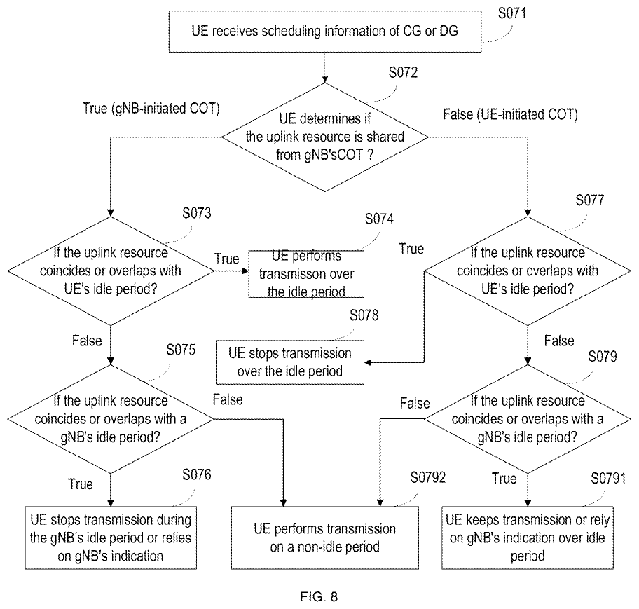

With reference to FIG. 8, the UE 10 receives scheduling information of a CG or DG uplink resource (S071) and determines if the uplink resource is shared from a gNB-initiated resource (e.g., a gNB-initiated COT) or a UE-initiated resource (e.g., a UE-initiated COT) (S072). The gNB-initiated resource may comprise a gNB-initiated COT, and the UE-initiated resource may comprise a UE-initiated COT.

If the uplink resource is shared from a gNB-initiated COT, the UE 10 determines if a location of the uplink resource coincides or overlaps with a UE's idle period (S073). A UE's idle period is an idle period in a UE's FFP, and a gNB's idle period is an idle period in a gNB's FFP. If the location of the uplink resource coincides or overlaps with a UE's idle period, the UE 10 can still perform UL transmission over the idle period (S074).

If the location of the uplink resource does not coincide or overlap with a UE's idle period, the UE 10 determines if the location of the uplink resource coincides or overlaps with a gNB's idle period (S075). If the location of the uplink resource coincides or overlaps with a gNB's idle period, the UE 10 stops the transmission during the gNB's idle period or relies on gNB's indication (S076) to determine UE's behavior regarding whether to perform UL transmission over an idle period of a gNB's FFP. If the location of the uplink resource does not coincide or overlap with a gNB's idle period, the UE 10 can still perform UL transmission over the uplink resource which may be referred to as a non-idle period (S0792).

If the uplink resource is a UE-initiated COT, the UE 10 determines if the location of the uplink resource coincides or overlaps with a UE's idle period (S077). If the location of the uplink resource coincides or overlaps with a UE's idle period, the UE 10 stops the transmission over the UE's idle period (S078).

If the location of the uplink resource does not coincide or overlap with a UE's idle period, the UE 10 determines if the location of the uplink resource coincides or overlaps with a gNB's idle period (S079). If the location of the uplink resource coincides or overlaps with a gNB's idle period, the UE 10 can still perform UL transmission over the gNB's idle period, or relies on gNB's indication to determine UE's behavior regarding whether to perform UL transmission over an idle period of a gNB's FFP (S0791). If the location of the uplink resource does not coincide or overlap with a gNB's idle period, the UE 10 can still perform UL transmission over the uplink resource which may be referred to as a non-idle period (S0792).

### Embodiment B1—Content of DCI Fields for Semi-Static Uplink Channel

In a semi-static channel access mode, if a UE (e.g., the UE 10) can operate as an initiating device (referred to as a COT initiator) and is scheduled by DCI for dynamic PUSCH transmission, the following contents can be included in corresponding DCI formats.

The DCI format of the DCI may comprise DCI format 0_0, 1_0, 1_2, 0_2, 1_1, or 0_1. The DCI may comprise one or more of:
(1). A channel access field;
(2). An independent COT initiator field;
(3). A cross FFP resource scheduling field; and
(4). A priority level indication.

For DCI format 0_0, 1_0, 1_2, 0_2, 1_1, or 0_1, at least one of the following fields can be included:

### (1). A Channel Access Field:

Each of the following contents in the channel access field can be always present, configured to be absent, or is only presented for either Load Based Equipment (LBE) mode or Frame Based Equipment (FBE) mode. For example, this field is always absent for FBE, can be configured to be absent for FBE, or always present for FBE or LBE.

The channel access field may comprise an indication of LBT type (i.e., no sensing or 9 us sensing), cyclic prefix (CP) extension, or channel access priority class (CAPC). Channel sensing schemes can be found in Embodiment B5.

The channel access field may comprise a COT initiator indication. The COT initiator indication indicates whether a scheduled PUSCH transmission is based on (or specifically, performed in) a UE-initiated COT or sharing a gNB-initiated COT.

The COT initiator indication can be an independent indicator in the channel access field or jointly encoded with the indication of LBT type, CP extension, or CAPC.

This channel access field can indicate the COT initiator of a current FFP and/or at least one of subsequent FFPs based on at least one of the following schemes:
In an embodiment, a single COT initiator indicated in the field can be applied to the current FFP and at least one of subsequent FFPs.
In an embodiment, a single COT initiator indicated in the field can only be applied to a current FFP, and the initiators of subsequent FFPs can be determined based on a predefined rule. The predefined rule, for example, comprises assuming a subsequent FFP whose COT is initiated by a UE, i.e., a UE-initiated u-FFP, if a PUSCH resource is aligned with the u-FFP.
In an embodiment, the independent COT initiator field comprises an individual COT initiator indication for a current FFP and an individual COT initiator indication for at least one of subsequent FFPs.
   If COT initiator indication is absent in the channel access field, configured grant (CG) based COT initiator determination or schemes in Embodiment B2 can be adopted. When an initiator of each of the scheduled UL transmissions is not present in the first DCI, the UE derives a COT initiator for each of the scheduled UL transmissions according to a rule used for configured grant (CG) based COT initiator determination.

In the embodiment, the COT initiator of each of the scheduled UL transmissions is indicated by a first COT initiator indication in the first DCI. The deriving the COT initiator of each of the scheduled UL transmissions is based on a first COT initiator indication in the first DCI. As detailed in Embodiment B1, the first COT initiator indication may be encoded in a channel access field of the first DCI. A DCI format of the first DCI used for first COT initiator indication includes DCI format 0_0, 1_0, 1_2, 0_2, 1_1, or 0_1. The first COT initiator indication may be applied to one or more FFPs. According to Embodiment A5, specifically A5-1, A5-2, and A5-2-1, the UL transmissions may comprise repetitions of a PUSCH transmission for a single transport block. The repetitions may be one or more nominal repetitions of a PUSCH transmission with repetition type B. Alternatively, UL transmissions may comprise multiple PUSCH transmissions, each of the multiple PUSCH transmissions carries a transport block.

In an example, the derived COT initiator is the UE. If a nominal repetition among the one or more nominal repetitions overlaps with an idle period of a COT initiated by the UE, the UE determines one or more symbols of the nominal repetition without overlapping with the idle period as the one or more transmission symbols and segments the nominal repetition into one or more actual repetitions.

When the base station receives each of scheduled UL transmissions in one or more transmission symbols of one or more FFPs, one or more symbols of the nominal repetition without overlapping with the idle period constitute the one or more transmission symbols.

In an example, the derived COT initiator is a base station. If a nominal repetition among the one or more nominal repetitions overlaps with an idle period of a COT initiated by the base station, the UE determines one or more symbols of the nominal repetition without overlapping with the idle period as the one or more transmission symbols and segments the nominal repetition into one or more actual repetitions. When the base station receives each of scheduled UL transmissions in one or more transmission symbols of one or more FFPs, one or more symbols of the nominal repetition without overlapping with the idle period constitute the one or more transmission symbols, and the nominal repetition is segmented into one or more actual repetitions.

In an example, the derived COT initiator is a base station. If a nominal repetition among the one or more nominal repetitions overlaps with an idle period of a COT initiated by the UE, all of one or more scheduled symbols of the nominal repetition are not transmitted, and all of one or more scheduled symbols of the nominal repetition are not received by the base station.

In an example, the derived COT initiator is the UE. If a scheduled PUSCH transmission of the multiple PUSCH transmissions overlaps with an idle period of a COT initiated by the UE, all of one or more symbols of the scheduled PUSCH transmission are not transmitted, and all of one or more symbols of the scheduled PUSCH transmission are not received by the base station.

### (2). An Independent COT Initiator Field:

This field is independent of the channel access field, and can be always present in the FBE mode or configured to be absent for the FBE mode, or only exists for the FBE mode.

This field can indicate the COT initiator of a current FFP and/or at least one of the subsequent FFPs based on at least one of the following schemes.
In an embodiment, a single COT initiator indicated in the field can be applied to the current FFP and at least one of subsequent FFPs.
In an embodiment, a single COT initiator indicated in the field can only be applied to a current FFP, and the initiators of subsequent FFPs are determined based on a predefined rule. The predefined rule, for example, comprises assuming a subsequent FFP whose COT is initiated by a UE, i.e., a UE-initiated u-FFP, if a PUSCH resource is aligned with the u-FFP.

In an embodiment, the independent COT initiator field comprises an individual COT initiator indication for a current FFP and an individual COT initiator indication for at least one of subsequent FFPs.

If this independent COT initiator field is absent, a scheme of determining a COT initiator based on the configured grant (CG) or schemes in Embodiment B2 can be adopted.

In an embodiment, the base station transmits downlink control information (DCI), and the DCI includes a COT initiator indication for one or more of the configured grant UL transmissions. The UE receives the DCI. One or more COT initiators of the one or more of the configured grant UL transmissions are determined based on the COT initiator indication in the DCI.

### (3). A Cross FFP Resource Scheduling Field:

A gNB (e.g., the gNB 20) can schedule UL/DL transmission(s) in this field for at least one of later g-FFP(s) that is different from the g-FFP that carries the scheduling DCI.

An indication of cross-FFP scheduling in the scheduling DCI may include a location of a later g-FFP with respect to the g-FFP that carries the scheduling DCI.

Indication schemes of cross-FFP PDSCH repetition and cross-FFP PUSCH repetition can be found in Embodiment B6 and Embodiment B7, respectively.

This cross FFP resource scheduling field can be a separated field or encoded together with the channel access field or the COT initiator field.

### (4). A Priority Level Indication:

In an embodiment, a priority level of each of the scheduled UL transmissions is determined based on a single indication in the DCI. Note that this priority level indication can be indicated in DCI for dynamic scheduling or in PUSCH/PUCCH relevant parameter configurations in a radio resource control (RRC) message.

In the semi-static channel access mode, if a UE (e.g., the UE 10) is scheduled for dynamic UL or CG UL transmission, the following applies. If the scheduled UL transmission is based on a UE-initiated COT, a gNB (e.g., the gNB 20) can indicate the UE at least one of the following for intra-UE prioritization: a priority level of a scheduled PUSCH transmission or a priority level of a scheduled PUCCH transmission.
A priority level of a scheduled PUSCH transmission can be indicated using a priority level index.
   [symbol] Dynamic PUSCH scheduling with a priority level index indicated in DCI
   [symbol] Configured grant PUSCH scheduling with a priority level index indicated in an activation DCI or in a CG configuration
A priority level of a scheduled PUCCH transmission.
   [symbol] A HARQ-ACK codebook transmitted in the PUCCH transmission is associated with a priority level index
   [symbol] An SR configuration transmitted in the PUCCH transmission is associated with a priority level index

Among PUSCH(s) and PUCCH(s), if collision of UL transmission occurs, the uplink channel with the highest priority level is transmitted.

In an embodiment, a priority level of each of the configured grant UL transmissions is configured based on a RRC signaling.

In an embodiment, a priority level of at least one of the configured grant UL transmissions is indicated in the DCI.

In an embodiment, the same COT initiator determination rule is applied to one or more FFPs for each of the configured grant UL transmissions.

### Embodiment B2—Absent of a COT Initiator Indication Field in DCI

In the semi-static channel access mode, if a UE (e.g., the UE 10) can operate as an initiating device and is scheduled for dynamic PUSCH transmission using DCI for intra-FFP and inter-FFP scheduling. If the COT initiator indication field is absent in DCI in at least one of FFPs, at least one of the following COT initiator determination schemes can be considered.
When the scheduled PUSCH transmission is within the g-FFP that carries the scheduling DCI:
   [symbol] If the starting point of the scheduled PUSCH is not aligned with a u-FFP boundary or the ending point of the scheduled PUSCH does not end before an idle period of that u-FFP, the UE (e.g., the UE 10) assumes that the scheduled PUSCH transmission corresponds to a gNB-initiated COT.
   [symbol] If the starting point of the scheduled PUSCH is aligned with a u-FFP boundary and the ending point of the scheduled PUSCH ends before the idle period of that u-FFP, the UE may determine the initiator based on the following schemes.
      ♦ Scheme 1: If the transmission is also confined within a g-FFP before the idle period of the g-FFP, and the UE has already determined that a gNB (e.g., the gNB 20) has initiated the g-FFP, the UE assumes that the scheduled PUSCH transmission corresponds to a gNB-initiated COT. Otherwise, the UE assumes that the scheduled PUSCH transmission corresponds to a UE-initiated COT.
      ♦ Scheme 2: The UE always assumes that the scheduled PUSCH transmission corresponds to a UE-initiated COT.
When the scheduled PUSCH transmission located in a later g-FFP that is different from the g-FFP carrying the scheduling DCI, and the starting point of the scheduled PUSCH is aligned with a boundary of a u-FFP and ends before an idle period of that u-FFP:
   [symbol] Scheme 1: If the transmission is confined within the later g-FFP before the idle period of the later g-FFP, and the UE has already determined that a gNB (e.g., the gNB 20) has initiated the later g-FFP, the UE assumes that the scheduled PUSCH transmission corresponds to a gNB-initiated COT. Otherwise, the UE assumes that the scheduled PUSCH transmission corresponds to a UE-initiated COT.
   [symbol] Scheme 2: The UE always assumes that the scheduled PUSCH transmission corresponds to a UE-initiated COT.

### Embodiment B2-1: (Example Procedure for Determining a COT Initiator

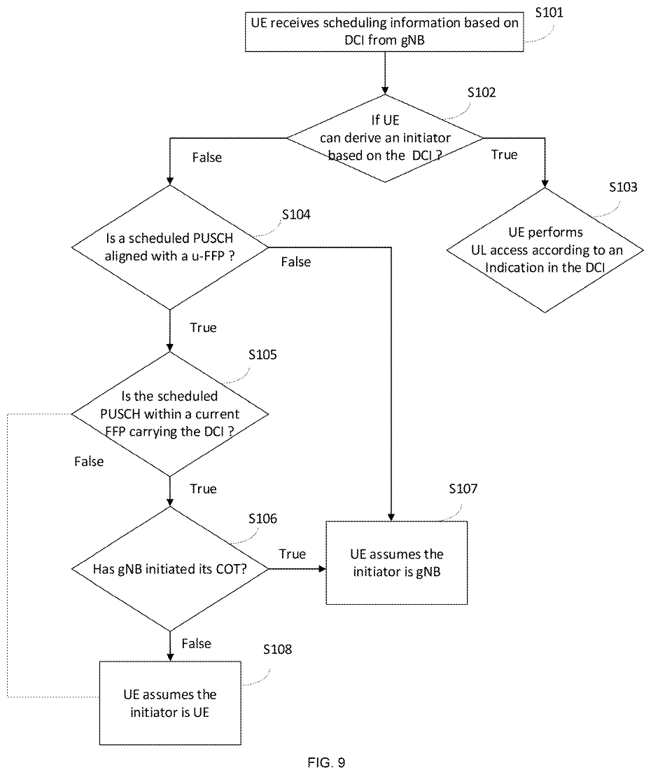

With reference to FIG. 9, UE (e.g., the UE 10) receives scheduling information of PUSCH based on the content in DCI received by the UE (S101).

If the information of an initiator in the DCI can be derived for at least one of scheduled FFPs (S102), the UE performs corresponding UL channel access based on the derived initiator for the scheduled FFP(s) (S103). Otherwise, if an initiator of at least one of scheduled FFP(s) cannot be derived, the UE determines whether the scheduled PUSCH transmission is aligned with a u-FFP boundary (S104).
If the scheduled PUSCH transmission is aligned with a u-FFP boundary, the UE determines whether the scheduled PUSCH transmission is within the g-FFP that carries the scheduling DCI (S105).
   [symbol] If the scheduled PUSCH transmission is within the g-FFP that carries the scheduling DCI, the UE determines whether the gNB scheduling the PUSCH transmission has initiated the g-FFP (S106).
      ♦ If the gNB has initiated the g-FFP, the UE assumes that the scheduled PUSCH transmission corresponds to a gNB-initiated COT (S107).
      ♦ If the gNB does not initiate the g-FFP, the UE assumes that the scheduled PUSCH transmission corresponds to a UE-initiated COT (S108).
   [symbol] If the scheduled PUSCH transmission is not within the g-FFP that carries the scheduling DCI (for example, the UE determines that the scheduled PUSCH transmission is within the later g-FFP without carrying the scheduling DCI), the UE assumes that the scheduled PUSCH transmission corresponds to a UE-initiated COT (S108).
If the UE determines that the scheduled PUSCH transmission is not aligned with a u-FFP boundary, the UE assumes that the scheduled PUSCH transmission corresponds to a gNB-initiated COT (S107).

### Embodiment B3 COT Initiator Indication Overwriting

In the semi-static channel access mode, if a UE (e.g., the UE 10) can operate as an initiating device and receives scheduling for dynamic UL transmission by receiving DCI for intra-FFP and inter-FFP scheduling, the following applies.
If a gNB (e.g., the gNB 20) has scheduled a UL transmission in an FFP and indicated that a UE is a COT initiator using a DCI. Before the UE has performed UL transmission within the scheduled FFP, the gNB can overwrite a previous indication of an initiator and/or a previous scheduled UL resource of a corresponding FFP in an original DCI through another DCI (referred to as overwriting DCI).
   [symbol] The transmission timing of the overwriting DCI needs to satisfy some relative timing restrictions with respect to at least two of the following parameters or as a function of at least one of the following parameters. The parameters comprise:
      ♦ A starting time or an ending time of an original DCI;
      ♦ A starting time or an ending time of an overwriting DCI;
      ♦ A starting time or an ending time of UL resources scheduled by the original DCI (referred to as previous scheduled UL resources);
      ♦ A starting time or an ending time of a re-scheduled UL resource;
      ♦ A mode of initiator updating that indicates an initiator is changed from UE to gNB or from gNB to UE;
      ♦ A starting time of a g-FFP or a u-FFP for current UL transmission; and
      ♦ A starting time of a g-FFP or a u-FFP scheduled by the overwriting DCI.
   [symbol] The following are some examples of relative timing restrictions:
      ♦ A time gap between the end of the original DCI and the start of the overwriting DCI should be greater than a predefined threshold.
      ♦ A time gap between the end of the overwriting DCI and the start of the previous scheduled UL resource should be greater than a predefined threshold.
      ♦ A time gap between the end of the overwriting DCI and the start of the FFP carrying the previous scheduled UL resource should be greater than a predefined threshold.
      ♦ If the initiator is updated, the values of above predefined thresholds may further depend on whether the mode of initiator updating is from UE to gNB or from gNB to UE. For example, a greater time gap is needed if the initiator is updated from gNB to UE.

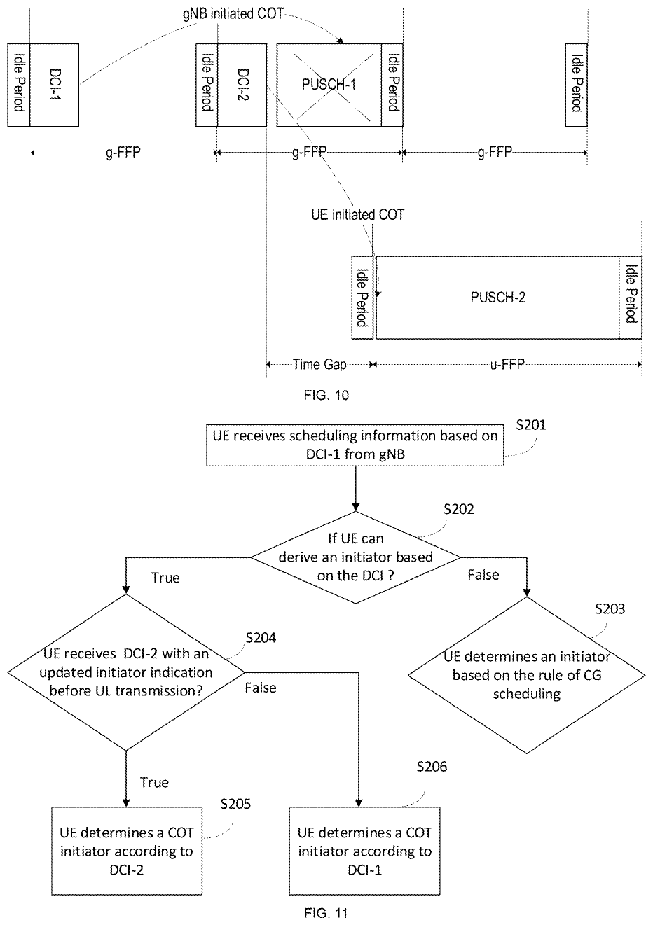

FIG. 10 illustrates the behaviour of an overwriting DCI (denoted as DCI-2) that overwrites an original initiator indication in an original DCI (denoted as DCI-1) for PUSCH scheduling from gNB to UE. An on-way arrow starting from DCI to a radio resource represents that the DCI schedules a transmission (i.e., transmission of a cross-FFP PUSCH, such as PUSCH-1 or PUSCH-2) in the radio resource. DCI-1 schedules transmission of PUSCH-1 in a g-FFP, and DCI-2 schedules transmission of PUSCH-2 in a u-FFP. The time gap between the end of overwriting DCI and the start of u-FFP should be greater than a threshold value.

In the embodiment, the base station transmits a second DCI later than the first DCI, and the second DCI includes a second COT initiator indication for at least one of the UL transmissions scheduled by the first DCI. The second COT initiator indicated in the second DCI overwrites at least one of COT initiators indicated in the first COT initiator indication for at least one of the UL transmissions scheduled by the first DCI. The UE receives a second DCI later than the first DCI, and the second DCI includes a second COT initiator indication for at least one of the UL transmissions scheduled by the first DCI. The second COT initiator indicated in the second DCI overwrites at least one of COT initiators indicated in the first COT initiator indication for at least one of the UL transmissions scheduled by the first DCI.

### Embodiment B3-1: (an Example of a Procedure of COT Initiator Overwriting)

With reference to FIG. 11, a UE (e.g., the UE 10) receives the scheduling information of PUSCH based on content in DCI (referred to as DCI-1) received by the UE (S201).

The UE determines whether a COT initiator can be derived from an original COT initiator indication in DCI-1 (S202).
If a COT initiator cannot be derived from an original COT initiator indication in DCI-1, the UE follows the COT initiator determination scheme based on the rule of CG scheduling (for example, in Embodiment A3-3) to determine a COT initiator (S203).
If a COT initiator can be derived from an original COT initiator indication in DCI-1, before the UE performs corresponding UL channel access based on an initiator indication in DCI-1 for an intended FFP:
   [symbol] If the UE received another DCI (referred to as DCI-2) carrying another initiator indication that updates the initiator indicated in the DCI-1 (S204) and/or carrying resource allocation that updates resource allocation scheduled by the DCI-1, and the overwriting timing restriction is satisfied, the UE performs updated UL channel access according to DCI-2 (S205) and/or follows an updated resource allocation based on DCI-2.
   [symbol] If the UE does not receive another DCI (i.e., DCI-2), the UE performs updated UL channel access according to the original COT initiator indication based on DCI-1 (S206).

### Embodiment B4-Interrupting UL Transmission and Modifying COT Initiator Indication

In the semi-static channel access mode, if a UE (e.g., the UE 10) can operate as an initiating device and is scheduled for dynamic UL transmission using DCI for intra-FFP and inter-FFP scheduling, the following applies.
If a gNB (e.g., the gNB 20) has scheduled a UL transmission in an FFP and has indicated a UE as a COT initiator using an original DCI, the gNB can use another DCI (referred to as cancellation DCI or switching DCI) to interrupt the UL transmission in the middle of a scheduled UL burst, change the initiator, and/or reschedule UL resource. The followings are possible scenarios.
   [symbol] The gNB can interrupt the UL transmission during the FFP initiated by the COT initiator indicated in a COT initiator indication of the original DCI.
   [symbol] The gNB can change the initiator to the gNB using a modified or previous scheduled UL resource after the UE has initiated a u-FFP and started UL transmission within the u-FFP.
   [symbol] The gNB can change the initiator to the UE using modified or previous scheduled UL resource after the UE has shared gNB's COT and started UL transmission within a g-FFP.
If the gNB has scheduled a UL transmission in an FFP and indicated a UE or a gNB as a COT initiator using a DCI, the gNB can use another DCI (referred to as cancellation DCI or switching DCI) to cancel/interrupt existing transmission or change previous initiator indication and/or previous scheduled UL resource of a corresponding FFP. The cancellation or change can be conducted after the UE has performed UL transmission according to the original DCI within the scheduled FFP.
   [symbol] The transmission timing of cancellation DCI or switching DCI needs to satisfy some relative timing restrictions with respect to at least two of the following parameters or as a function of at least one of the following parameters. The parameters comprise:
      ♦ A starting time or an ending time of an original DCI;
      ♦ A starting time or an ending time of cancellation/switching DCI;
      ♦ A starting time or an ending time of UL resources scheduled by the original DCI (referred to as previous scheduled UL resources);
      ♦ A starting time or an ending time of a rescheduled UL resource in the switching DCI;
      ♦ A mode of initiator updating that indicates an initiator is changed from UE to gNB or from gNB to UE; and
      ♦ A starting time of a g-FFP or a u-FFP for current UL transmission; and
      ♦ A starting time of a g-FFP or a u-FFP scheduled by the cancellation/switching DCI.
   [symbol] The followings are some examples of relative timing restrictions
      ♦ A time gap between the end of the original DCI and the start of switching DCI should be greater than a predefined threshold.
      ♦ A time gap between the end of cancellation DCI and the start of originally scheduled UL resource should be greater than a predefined threshold.
      ♦ A time gap between the end of switching DCI and the start of re-scheduled UL resource should be greater than a predefined threshold.
      ♦ A time gap between the end of switching DCI and the start of the FFP carrying the scheduled UL resource should be greater than a predefined threshold.
      ♦ If the initiator is switched, the value of above predefined thresholds may further depend on whether the mode of initiator updating is from UE to gNB or from gNB to UE. For example, a greater time gap is needed if the initiator is switched from gNB to UE.

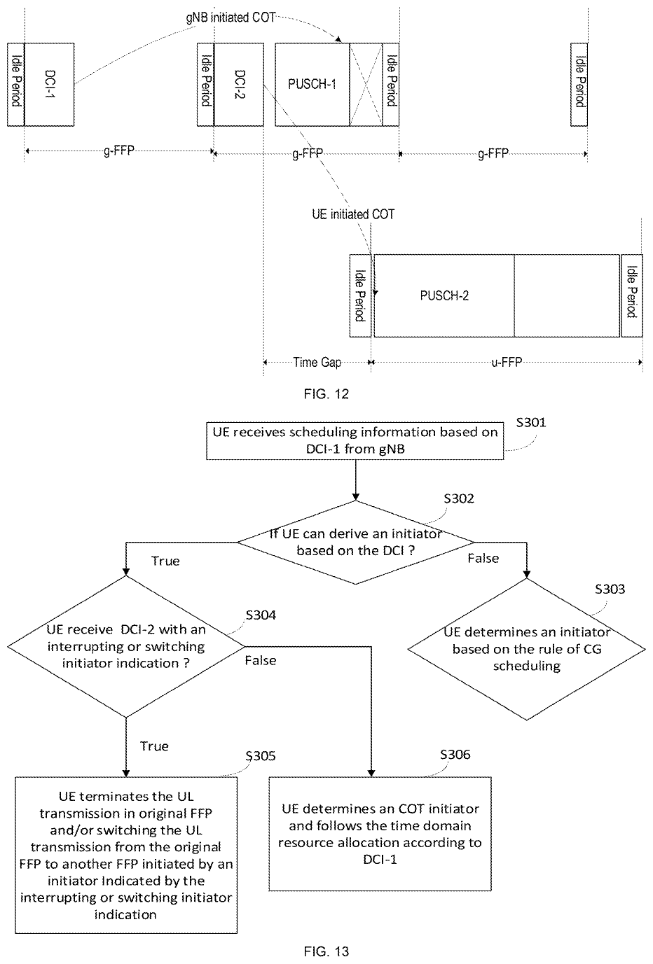

FIG. 12 illustrates the behaviour of switching an original initiator indication in DCI-1 for PUSCH transmission from gNB to UE via switching DCI-2. An on-way arrow starting from DCI to a radio resource represents that the DCI schedules a transmission (i.e., a PUSCH, such as PUSCH-1 or PUSCH-2) in the radio resource. DCI-1 schedules transmission of PUSCH-1 in a g-FFP, and DCI-2 schedules transmission of PUSCH-2 in a u-FFP. In the example, the uplink transmission in g-FFP is interrupted in the middle and switched to a u-FFP, a time gap between the end of switching DCI (i.e., DCI-2) and the start of the u-FFP should be greater than a threshold value.

### Embodiment B4-1: (an Example of a Procedure of Modifying or Switching a COT Initiator)

With reference to FIG. 13, a UE (e.g., the UE 10) receives the scheduling information of PUSCH based on content in DCI (referred to as DCI-1) received by the UE (S301).

The UE determines whether a COT initiator can be derived from an original COT initiator indication in DCI-1 (S302).

If a COT initiator cannot be derived from an original COT initiator indication in DCI-1, the UE follows COT initiator determination scheme based on the rule of CG scheduling (S303).

If a COT initiator can be derived from an original COT initiator indication in DCI-1:
If the UE received another DCI (referred to as DCI-2) carrying another initiator indication that interrupted or switched the initiator indicated in the DCI-1 (S304), and the timing restriction is satisfied, the UE terminates the UL transmission in the middle of an original FFP or switches from an original FFP with a COT initiated by an original initiator to another FFP with a COT initiated by another initiator according to DCI-2 (S305) and follows an updated resource allocation based on DCI2.
If the UE does not receive another DCI (i.e., DCI-2), the UE follows the original COT initiator indication and time domain resource allocation based on DCI-1 (S306).

### Embodiment B5: Channel Sensing Scheme

In the semi-static channel access mode, if a UE (e.g., the UE 10) can operate as an initiating device and is scheduled for dynamic PUSCH transmission using DCI, following sensing scheme can be provided in the channel access field in DCI.
If a gNB (e.g., the gNB 20) instruct the UE to operate as an initiating device:
   [symbol] The gNB can instruct the UE to transmit a UL burst starting at the beginning of a COT immediately after sensing the channel to be idle for at least a sensing slot duration Tₛₜ=9 us. If the channel is sensed to be busy, the UE shall not perform any transmission during the current period.
   [symbol] The gNB can instruct the UE to transmit a UL burst starting after the beginning of the UE-initiated COT without sensing the channel if the UE has already initiated the COT.
   [symbol] The gNB can instruct the UE to transmit a UL burst starting after the beginning of the UE-initiated COT without sensing the channel if the gNB has already indicated the UE as an initiator of the u-FFP carrying dynamically scheduled PUSCH.
If the gNB instructs the UE to share the gNB's COT:
   [symbol] The gNB can indicate the UE to transmit a UL burst after a DL burst without sensing the channel within a g-FFP if the gNB has initiated the g-FFP and a gap between the UL burst and the DL burst is at most 16 us.
   [symbol] The gNB can indicate the UE to transmit a UL burst after a DL burst after sensing the channel to be idle for at least a sensing slot duration Tₛₜ=9 us within a 25 us interval if a gap between the UL burst and the DL burst is more than 16 us.

In an embodiment, a channel access scheme is further indicated in the channel access field. The UE further receives the channel access scheme in the channel access field. The channel access scheme indicates the UE to transmit the scheduled UL transmissions starting at the beginning of a COT immediately after sensing the channel to be idle for at least a sensing slot duration of 9 us.

### Embodiment B6-Cross-FFP DL Scheduling

In the embodiment, cross-FFP DL scheduling in the semi-static channel access mode supports scheduling of totally more than one PDSCHs across more than one g-FFPs using dynamic DCI or based on SPS configuration. Each PDSCH may have the same TB (for PDSCH repetitions) or different TBs (for multi-TBs DL scheduling). Following scheduling schemes can be used to determine time domain resources. PDSCH repetition Type A:
A time domain resource assignment field in the DCI or in SPS configuration includes a row index in an allocation table. A row indexed by an index can map to a set of parameters which can be used to determine at least one of following parameters:
   [symbol] Ag-FFP offset (e.g., an offset with respect to the g-FFP carrying scheduling DCI or the start of an SPS period) which determines a time location of a corresponding g-FFP.
   [symbol] A slot offset of the corresponding g-FFP with respect to the first slot of the corresponding g-FFP, where the slot offset determines a time location of a slot.
   [symbol] A symbol location based on a start and length indicator SLIV within the slot determined by the slot offset.
If pdsch-AggregationFactor is configured in pdsch-config for PDSCH scheduled with a corresponding PDCCH or in sps-Config for PDSCH (i.e., SPS transmission activated by DCI) scheduled without corresponding PDCCH, the same symbol allocation (i.e., the symbol location) is applied across the pdsch-AggregationFactor consecutive slots. If number of the pdsch-AggregationFactor consecutive slots is greater than the length of a g-FFP period, PDSCH repetitions are transmitted across g-FFP boundaries and distributed among different g-FFPs.
   [symbol] The gNB should initiate each one of the g-FFPs carrying PDSCH repetitions.
      ♦ PDCCH can be omitted in one or more scheduled g-FFPs if the PDSCH resource is aligned with a starting point of the one or more scheduled g-FFP.
      ♦ PDCCH transmitted at or before anyone of the one or more scheduled g-FFPs can overwrite time domain resource previously scheduled by an activation DCI.
   [symbol] Transmission of any PDSCH repetition during an idle period of any g-FFP is cancelled.
   [symbol] If the gNB fails to initiate COT of a later g-FFP carrying at least one of PDSCH repetitions, the at least one of PDSCH repetitions is omitted.

FIG. 14 illustrates the indication of slot-based cross-FFP PDSCH repetition. An on-way arrow starting from DCI to a radio resource represents that the DCI schedules a transmission (i.e., transmission of cross-FFP PDSCH repetitions) in the radio resource.

### PDSCH Repetition Type B:

A time domain resource assignment field in the DCI or in SPS configuration includes a row index in an allocation table. A row indexed by an index can map to a set of parameters which can be used to determine at least one of the following values:
   [symbol] A g-FFP offset (e.g., an offset with respect to the g-FFP carrying scheduling DCI or the start of an SPS period) which determines a time location of a corresponding g-FFP.
   [symbol] A slot offset of the corresponding g-FFP with respect to the first slot of the corresponding g-FFP, where the slot offset determines a time location of a slot.
   [symbol] A symbol location based on a start symbol S and an allocation length L within the slot determined by the slot offset.
   [symbol] A repetition number of non-slot-based back-to-back transmissions, including transmission of non-slot-based back-to-back PDSCH repetitions and non-slot-based back-to-back PUSCH repetitions.
Non-slot-based back-to-back PDSCH repetitions, e.g., PDSCH repetition Type B, is supported for nominal PDSCH repetitions.
   [symbol] For PDSCH scheduled by DCI, e.g., format 1_1 or 1_2, if a repetition type indicator, e.g., PDSCHRepTypeIndicator-ForDCIFormat1_1 or PDSCHRepTypeIndicator-ForDCIFormat1_2, is set to PDSCH repetition type B, the UE (e.g., the UE 10) applies a PDSCH repetition Type B procedure when determining the time domain resource allocation. Otherwise, the UE applies PDSCH repetition based on pdsch-AggregationFactor, e.g., PDSCH repetition Type A with slot-based repetition when determining the time domain resource allocation for PDSCH scheduled by PDCCH.
   [symbol] For PDSCH repetition Type B,
      ♦ the PDSCH resource mapping type is based on Type B, i.e., mini-slot (non-slot-based) scheduling.
      ♦ Transmission of nominal PDSCH repetitions crossing slot boundary and/or crossing g-FFP boundary is supported.
      ♦ A UE (e.g., the UE 10) assumes the symbols during the idle period of any g-FFP are invalid.
         After determining the invalid symbol(s) for PDSCH repetition type B transmission for each of the nominal repetitions, the remaining symbols are considered by UE as valid symbols for PDSCH repetition Type B transmission.
         If the number of valid symbols for PDSCH repetition type B transmission is greater than zero for a nominal repetition, the nominal repetition can be separated into one or more actual repetitions, where each actual repetition consists of a consecutive set of valid symbols that can be used for PDSCH repetition Type B transmission within a slot [symbol]
         Rate matching around invalid symbols or puncturing around invalid symbols can be used for PDSCH resource mapping for each repetition.

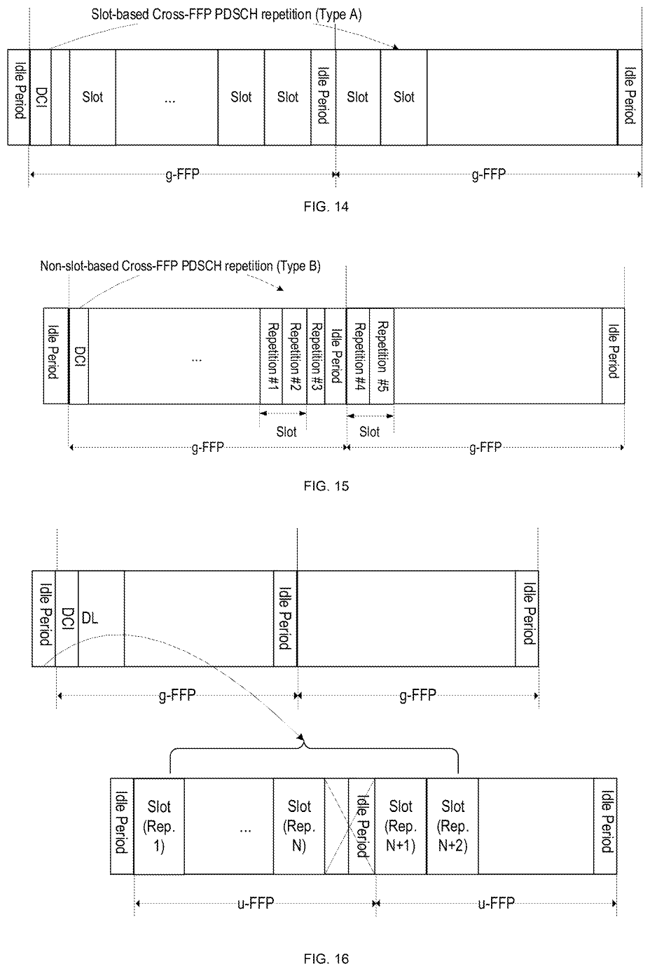

FIG. 15 illustrates the indication of non-slot-based (Type B) cross-FFP PDSCH repetition. In the example, the repetitions across a g-FFP boundary, and the symbols in an idle period during any repetition are viewed as invalid symbols. Any nominal repetition interrupted by invalid symbols can be separated into one or more actual repetitions. In this example, each slot is allocated with two repetitions, and the third repetition (repetition #3) is an actual repetition with less valid symbols than any other nominal repetition due to invalid symbols in the idle period. An on-way arrow starting from DCI to a radio resource represents that the DCI schedules a transmission (i.e., the transmission of cross-FFP PDSCH repetitions) in the radio resource.

### Embodiment B7: Cross-FFP UL Scheduling

In an embodiment, cross-FFP UL scheduling in the semi-static channel access mode supports scheduling of totally more than one PUSCH across more than one g-FFPs/u-FFPs using dynamic DCI or based on CG configuration. Each PUSCH corresponds to the same TB (for PUSCH repetitions). Alternatively, the more than one PUSCH are different TBs (for multi-TBs UL scheduling). At least one of the following scheduling schemes can be adopted.

For existing NR Type A or Type B PUSCH repetition:
A time domain resource assignment field in the DCI or in CG configuration may include a row index in an allocation table. A row indexed with the row index in the allocation table can map to a set of parameters which can determine at least one of the following parameters:
   [symbol] a g-FFP/u-FFP offset (e.g., an offset with respect to the g-FFP carrying scheduling DCI or with respect to start of a CG period) which determines a time location of a g-FFP/u-FFP.
   [symbol] a slot offset with respect to the starting slot of the g-FFP/u-FFP, where the slot determines a time location of a slot within the g-FFP/u-FFP.
   [symbol] a symbol location based on a start and length indicator value (SLIV) within the slot determined by the slot offset.
   [symbol] a repetition number of PUSCH, where the repetition number determines a total number of repetitions of the PUSCH.
For PUSCH repetition type A or type B, if the number of repetitions K across the K consecutive slots in DCI or CG configuration is greater than the length of a g-FFP/u-FFP period, the PUSCH repetitions are transmitted by UE across g-FFP/u-FFP boundaries and are distributed among different FFPs. A repetition of the PUSCH is referred to as a PUSCH repetition. Time domain resources scheduled for the PUSCH repetitions are referred to as PUSCH repetition resources.
   [symbol] A gNB (e.g., the gNB 20) can indicate an initiator of each PUSCH repetitions using DCI or CG configuration.
   [symbol] For a gNB initiated COT, the gNB should initiate g-FFPs to carry PUSCH repetitions.
      ♦ PDCCH transmitted at or before anyone of scheduled g-FFPs can overwrite time domain resources previously scheduled in the DCI or CG configuration for the PUSCH repetitions.
      ♦ If one of PUSCH repetition resources is aligned with the start of a u-FFP and a UE (e.g., the UE 10) have determined that the UE itself is the initiator, the UE should initiate the COT.
   [symbol] Transmission of PUSCH repetition is cancelled during an idle period of a u-FFP.
   [symbol] If the gNB or the UE fails to initiate one FFP of their FFPs, the PUSCH repetitions in the FFP are omitted

FIG. 16 illustrates the indication of slot-based (Type A) cross-FFP PUSCH repetition in UE-initiated COTs. In FIG. 16, the repetitions are scheduled crossing u-FFP boundary, and transmission of the repetition during an idle period is cancelled. An on-way arrow starting from DCI to a radio resource represents that the DCI schedules a transmission (i.e., transmission of cross-FFP PUSCH repetitions denoted as Rep) in the radio resource.

In an embodiment, time domain resources of the one or more nominal repetitions of the PUSCH transmission with repetition type B are determined based on a row index of a corresponding resource mapping table.

In an embodiment, if the derived COT initiator is the UE and if a configured grant PUSCH transmission overlaps with an idle period of a COT initiated by the UE, all of one or more symbols within the configured grant PUSCH transmission are not transmitted by the UE, and all of one or more symbols within the configured grant PUSCH transmission are not received by the base station.

In an embodiment, if the derived COT initiator is a base station and if a configured grant PUSCH transmission overlaps with an idle period of a COT initiated by the base station, all of one or more symbols within the configured grant PUSCH transmission are not transmitted by the UE, and all of one or more symbols within the configured grant PUSCH transmission are not received by the base station.

### Embodiment B8

Any schemes, options, and examples in each of the embodiments, either for UE-initiated COT configuration or for harmonization features in NR-U CG or URLLC DG, can be adopted to work together using various combinations for different purposes.

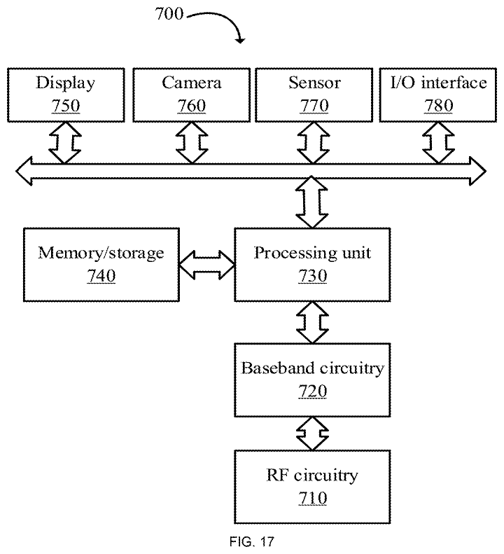

FIG. 17 is a block diagram of an example system 700 for wireless communication according to an embodiment of the present disclosure. Embodiments described herein may be implemented into the system using any suitably configured hardware and/or software. FIG. 17 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skills in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A channel access method in an unlicensed spectrum for execution by a user equipment (UE), comprising:
receiving a first downlink control information (DCI) within a fixed frame period (FFP), wherein the first DCI is for scheduling uplink (UL) transmissions over one or more FFPs;
deriving, for each scheduled UL transmission of the scheduled UL transmissions, a channel occupancy time (COT) initiator of the scheduled UL transmission;
determining one or more transmission symbols for each of the scheduled UL transmissions according to the derived COT initiator; and
transmitting each of the scheduled UL transmissions in the one or more transmission symbols of the one or more FFPs.

2. The channel access method of claim 1, wherein the deriving the COT initiator of each of the scheduled UL transmissions is based on a first COT initiator indication in the first DCI.

3-5. (canceled)

5. The channel access method of claim 1, wherein the UL transmissions comprises repetitions of a PUSCH transmission for a single transport block, and the repetitions are one or more nominal repetitions of a PUSCH transmission with repetition type B.

6. The channel access method of claim 5, wherein the derived COT initiator is the UE, and if a nominal repetition among the one or more nominal repetitions overlaps with an idle period of a COT initiated by the UE, the UE determines one or more symbols of the nominal repetition without overlapping with the idle period as the one or more transmission symbols and segments the nominal repetition into one or more actual repetitions.

7. The channel access method of claim 5, wherein the derived COT initiator is a base station, and if a nominal repetition among the one or more nominal repetitions overlaps with an idle period of a COT initiated by the base station, the UE determines one or more symbols of the nominal repetition without overlapping with the idle period as the one or more transmission symbols and segments the nominal repetition into one or more actual repetitions.

8. The channel access method of claim 5, wherein the derived COT initiator is a base station, and if a nominal repetition among the one or more nominal repetitions overlaps with an idle period of a COT initiated by the UE, all of one or more scheduled symbols of the nominal repetition are not transmitted.

9. (canceled)

10. The channel access method of claim 2, wherein the first COT initiator indication is encoded in a channel access field of the first DCI, and a DCI format of the first DCI used for first COT initiator indication includes DCI format 0_0.

11. (canceled)

12. The channel access method of claim 2, wherein the first COT initiator indication is applied to one or more FFPs.

13. (canceled)

14. The channel access method of claim 2, wherein the UE receives a second DCI later than the first DCI, and the second DCI includes a second COT initiator indication for at least one of the UL transmissions scheduled by the first DCI; and
wherein the second COT initiator indicated in the second DCI overwrites at least one of COT initiators indicated in the first COT initiator indication for at least one of the UL transmissions scheduled by the first DCI.

15. (canceled)

16. The channel access method of claim 10, wherein the UE further receives a channel access scheme in the channel access field, the channel access scheme indicates the UE to transmit the scheduled UL transmissions starting at the beginning of a COT immediately after sensing the channel to be idle for at least a sensing slot duration of 9 us.

17. (canceled)

18. The channel access method of claim 1, wherein an initiator of each of the scheduled UL transmissions is not present in the first DCI, and the UE derives a COT initiator for each of the scheduled UL transmissions according to a rule used for configured grant (CG) based COT initiator determination.

19-23. (canceled)

24. A channel access method in an unlicensed spectrum for execution by a base station, comprising:
transmitting a first downlink control information (DCI) within a fixed frame period (FFP),
wherein the first DCI is for scheduling uplink (UL) transmissions over one or more FFPs; and
receiving each of scheduled UL transmissions in one or more transmission symbols of one or more FFPs;
wherein the one or more transmission symbols for each scheduled UL transmission of the scheduled UL transmissions are determined according to a channel occupancy time (COT) initiator for the scheduled UL transmission.

25. The channel access method of claim 24, wherein the COT initiator of each of the scheduled UL transmissions is indicated by a first COT initiator indication in the first DCI.

26-27. (canceled)

28. The channel access method of claim 25, wherein the UL transmissions comprises repetitions of a PUSCH transmission for a single transport block, the repetitions are one or more nominal repetitions of a PUSCH transmission with repetition type B.

29. The channel access method of claim 28, wherein the COT initiator is a user equipment (UE), and if a nominal repetition among the one or more nominal repetitions overlaps with an idle period of a COT initiated by the UE, one or more symbols of the nominal repetition without overlapping with the idle period constitute the one or more transmission symbols, and the nominal repetition is segmented into one or more actual repetitions.

30. The channel access method of claim 28, wherein the COT initiator is the base station, and if a nominal repetition among the one or more nominal repetitions overlaps with an idle period of a COT initiated by the base station, one or more symbols of the nominal repetition without overlapping with the idle period constitute the one or more transmission symbols, and the nominal repetition is segmented into one or more actual repetitions.

31. The channel access method of claim 28, wherein the COT initiator is the base station, and if a nominal repetition among the one or more nominal repetitions overlaps with an idle period of a COT initiated by a user equipment (UE), all of one or more scheduled symbols of the nominal repetition are not received by the base station.

32. (canceled)

33. The channel access method of claim 25, wherein the first COT initiator indication is encoded in a channel access field of the first DCI, a DCI format of the first DCI used for first COT initiator indication includes DCI format 0_0, and the first COT initiator indication is applied to one or more FFPs.

34-36. (canceled)

37. The channel access method of claim 25, wherein the base station transmits a second DCI later than the first DCI, and the second DCI includes a second COT initiator indication for at least one of the UL transmissions scheduled by the first DCI; and
wherein the second COT initiator indicated in the second DCI overwrites at least one of COT initiators indicated in the first COT initiator indication for at least one of the UL transmissions scheduled by the first DCI.

38. (canceled)

39. The channel access method of claim 33, wherein a channel access scheme is further indicated in the channel access field, the channel access scheme indicates a user equipment (UE) to transmit the scheduled UL transmissions starting at the beginning of a COT immediately after the UE senses the channel to be idle for at least a sensing slot duration of 9 us.

40-46. (canceled)
